(19) United States
(12) Patent Application Publication
(10) Pub. No.: US 2008/0117453 A1
(43) Pub. Date: May 22, 2008

(54) IMAGE PROCESSOR, IMAGE PROCESSING METHOD, AND LINKED PRINTING CONTROL SCREEN GENERATION METHOD

(76) Inventor: Yoshiyuki Toda, Kanagawa (JP)

Correspondence Address: COOPER & DUNHAM, LLP, 1185 AVENUE OF THE AMERICAS, NEW YORK, NY, 10036, US

(21) Appl. No.: 11/940,094

(22) Filed: Nov. 14, 2007

(30) Foreign Application Priority Data
Nov. 21, 2006 (JP) 2006-314666
Nov. 21, 2006 (JP) 2006-314667

(51) Int. Cl. G06K 1/00

(52) U.S. Cl. 358/1.15

(57) ABSTRACT

An image processor implementing a linked printing function is disclosed that includes a communications part configured to perform communications with an external image processor having a slave unit function of linked printing; an image forming filter configured to execute a job of image forming with an image forming part; a slave unit output filter configured to instruct the external image processor to execute the job of the image forming through the communications part; and a linked printing filter configured to distribute the job of the image forming between the image forming filter and the slave unit output filter.

### BACKGROUND OF THE INVENTION

1. Field of the Invention

The present invention relates to an image processor, an image processing method, and a linked printing control screen generation method.

2. Description of the Related Art

Conventionally, there has been the technique of linked printing (or linkage printing) that connects multiple image processors and outputs the image of original material such as a document not only from an image processor to which the image has been input but also from other image processors. Functions of implementing a job by linking (or connecting) multiple image processors such as linked facsimile that performs facsimile transmission instead of outputting images, are collectively referred to as “linkage function.”

For example, Patent Document 1 listed below shows the technique of calibration for color correction at the time of performing linked printing. According to Patent Document 1, a first color copier that reads an image reads a calibration pattern, and transmits the read data to a second color copier that outputs the image. The second color copier performs calibration based on the read data, thereby obtaining image processing parameters corresponding to the reading characteristics of the first color copier through operations.

For example, Patent Document 2 listed below shows an image processor technology where a list of printers connected to a printer via a network is displayed and a printer to output an image is selected from the list at the time of selecting a printer for linked printing.

[Patent Document 1] Japanese Laid-Open Patent Application No. 2002-10083

[Patent Document 2] Japanese Laid-Open Patent Application No. 2004-102377

However, according to the image forming system shown in Patent Document 1, at the time of performing linked printing, it is assumed that each of an image processor to which an image is input (hereinafter referred to as “master unit”) and an image processor to output the image (hereinafter referred to as “slave unit”) has the function of linked printing in advance, and means corresponding to the linkage function and means corresponding to other functions are not clearly divided.

Therefore, adding the linkage function to an image processor without the linkage function such as linked printing or linked copying makes it necessary to change many means of the image processor, thus requiring not only a large amount of labor but also people having technical abilities such as performing maintenance. Therefore, it cannot be achieved with ease.

Further, in the linked printing, the efficiency of a job of linked printing can be maximized by causing multiple printers to simultaneously finish printing out an image. Further, in the case where printers have different image forming speeds or each printer has a job in execution, by selecting printers in consideration of this, linked printing can be performed in as short a time as possible. According to the image processor shown in Patent Document 2, however, it is not taken into consideration how to display the identification information of multiple printers in the list displayed as candidate printers for performing linked printing.

### SUMMARY OF THE INVENTION

Embodiments of the present invention may solve or reduce one or more of the above-described problems.

According to one embodiment of the present invention, there are provided an image processor, an image processing method, and a linked printing control screen generation method in which one or more of the above-described problems may be solved or reduced.

According to one embodiment of the present invention, there is provided an image processor capable of easily adding a linkage function by combining the image forming function and the communications functions of the image processor with a function to be newly added.

According to one embodiment of the present invention, there is provided an image processor that generates a screen suitably displaying a list of image processors that are candidate slave units in the case of implementing a linkage function, thereby facilitating selection of a slave unit.

According to one embodiment of the present invention, there is provided an image processor implementing a linked printing function, including a communications part configured to perform communications with an external image processor having a slave unit function of linked printing; an image forming filter configured to execute a job of image forming with an image forming part; a slave unit output filter configured to instruct the external image processor to execute the job of the image forming through the communications part; and a linked printing filter configured to distribute the job of the image forming between the image forming filter and the slave unit output filter.

As a result, it is possible to provide an image processor to which a linkage function can be added easily by combining the image forming function and the communications functions of the image processor with a function to be newly added.

According to one embodiment of the present invention, there is provided an image processor implementing a linked printing function, including a reception filter configured to receive a job instruction transmitted from an external image processor having a master unit function of linked printing, the job instruction containing image data and a number of outputs of an image to be formed based on the image data; an image forming filter configured to output an instruction to form the image to an image forming part; and a slave unit printing part configured to output the image data and the number of outputs to the image forming filter based on the job instruction from the external image processor.

As a result, it is possible to provide an image processor that implements a slave unit function of linked printing by a combination of filters.

According to one embodiment of the present invention, there is provided a computer program to be added to an image processor as a plug-in, the image processor including a communications part configured to perform communications with an external image processor having a slave unit function of linked printing; an image forming filter configured to execute a job of image forming with an image forming part; and a slave unit output filter configured to instruct the external image processor to execute the job of the image forming through the communications part, wherein the computer program causes the image processor to execute a step of distributing the job of the image forming between the image forming filter and the slave unit output filter.

According to one embodiment of the present invention, there is provided a computer-readable recording medium on which is recorded the above-described computer program.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing parts of an MFP, which is an image processor according to one embodiment of the present invention;

FIG. 2 is a diagram for illustrating the concept of pipes and filters architecture according to one embodiment of the present invention;

FIG. 3 is a block diagram showing a functional configuration of the MFP, which is an image processor according to one embodiment of the present invention;

FIG. 4 is a diagram showing an example connection of image processors that implements linked copying according to one embodiment of the present invention;

FIG. 5 is a diagram showing a sequence of generating a slave unit selection screen that displays candidate slave units according to one embodiment of the present invention;

FIGS. 6A and 6B are diagrams for illustrating a slave unit selection screen displayed on a local UI part according to one embodiment of the present invention;

FIG. 7 is a sequence diagram illustrating processing in a master unit in the case of performing sort printing by linked printing according to one embodiment of the present invention;

FIGS. 8A and 8B are diagrams for illustrating a screen that displays job progress according to one embodiment of the present invention;

FIG. 9 is a sequence diagram illustrating processing in a slave unit in the case of performing sort printing by linked printing according to one embodiment of the present invention;

FIG. 10 is a sequence diagram illustrating processing in a master unit in the case of performing stack printing according to one embodiment of the present invention;

FIG. 11 is a sequence diagram illustrating processing in the case of occurrence of a jam in a master unit during execution of a job of linked printing according to one embodiment of the present invention;

FIG. 12 is a sequence diagram illustrating processing in a master unit in the case of occurrence of a jam in a slave unit during execution of a job of linked printing according to one embodiment of the present invention;

FIG. 13 is a sequence diagram illustrating processing in a slave unit in the case of occurrence of a jam in the slave unit during execution of a job of linked printing according to one embodiment of the present invention;

FIG. 14 is a table illustrating job distribution in the case of implementing sort printing by linked printing according to one embodiment of the present invention;

FIG. 15 is a table illustrating job distribution in the case of implementing stack printing by linked printing according to one embodiment of the present invention;

FIG. 16 is a diagram illustrating configuring software implementing linked copying as a plug-in according to one embodiment of the present invention;

FIG. 17 is a diagram showing an example connection of image processors that implements a linked facsimile function according to one embodiment of the present invention; and

FIG. 18 is a block diagram showing a computer configuration implementing an image processor according to one embodiment of the present invention.

### DETAILED DESCRIPTION OF THE PREFERRED EMBODIMENTS

A description is given, with reference to the accompanying drawings, of embodiments of the present invention.

In the following embodiments, a description is given taking a multi-function peripheral (or a multi-function machine) (hereinafter referred to as “MFP”) as an example of the image processor. However, the image processor of the present invention is not limited to an MFP and may be any image processor that implements a linkage function by communicating with another image processor.

### Embodiments

(Configuration of Parts Executing Jobs of MFP)

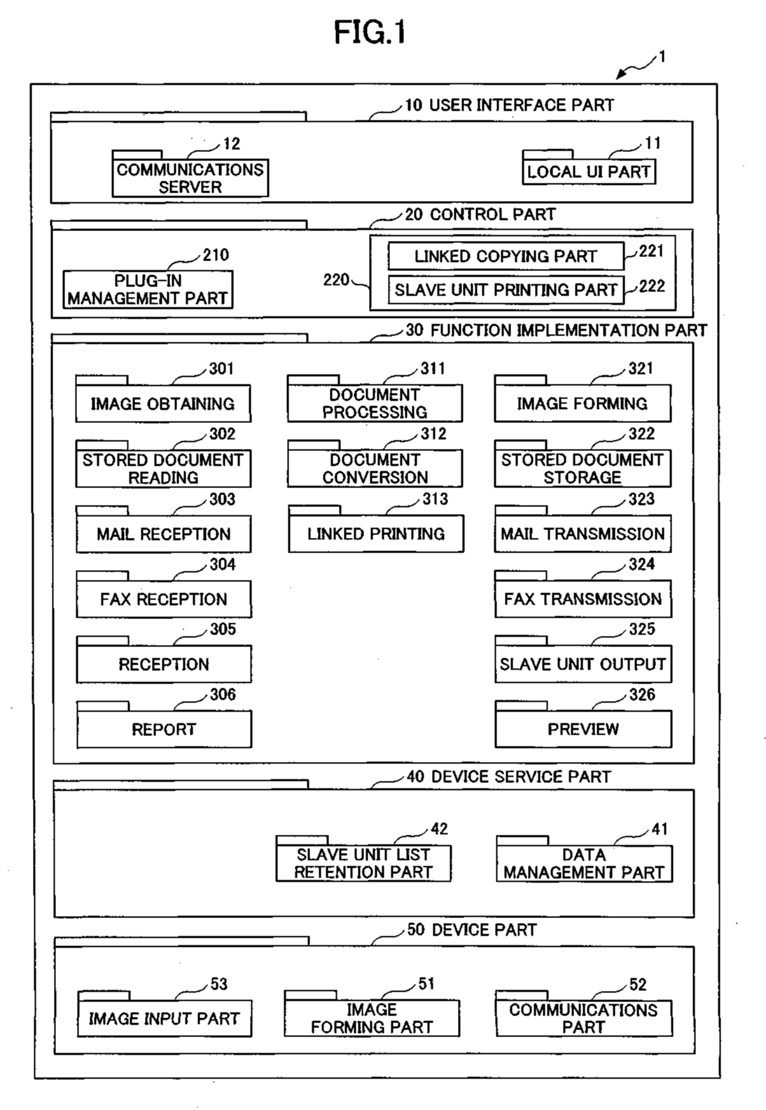

FIG. 1 is a block diagram showing parts of an MFP 1, which is an image processor according to one embodiment of the present invention.

FIG. 1 mainly shows a configuration of software that implements jobs of the MFP 1. Here, the term “MFP” may refer to an image forming apparatus that implements multiple functions such as printing, copying, scanning, and facsimile in a single enclosure.

Referring to FIG. 1, the software in the MFP 1 includes a user interface part 10, a control part 20, a function implementation part 30, a device service part 40, and a device part 50. In FIG. 1, the parts 10 through 50 are shown in a hierarchy, which is based on their calling relationships. That is, basically, an upper layer calls a lower layer in FIG. 1.

The user interface part 10, where a function for receiving a request to execute a job (such as copying, printing, scanning, or facsimile transmission) is implemented, includes, for example, a local user interface (hereinafter, “local UI”) part 11 and a communications server part 12. The local UI part 11, for example, accepts a request input through an operations panel (not graphically illustrated). The communications server part 12, for example, accepts a request from a client PC (not graphically illustrated) via a network. Requests accepted in the user interface part 10 are communicated to the control part 20.

The control part 20, where a function for controlling processing for executing a requested job is implemented, includes, for example, a plug-in management part 210 that manages a function added as a plug-in. In this embodiment, the “plug-in” includes a program or device corresponding to a function newly added to the basic functions of the MFP 1 and programs and devices corresponding to the basic functions of the MFP 1.

The control part 20 further includes a linked copying part 221 or a slave unit printing part 222 as a part that generates a job by connecting filters possessed by the function implementation part 30 with a pipe. The linked copying part 221 implements the function of a master unit of linked copying. The slave unit printing part 222 implements the function of a slave unit of linked printing.

In the function implementation part 30, components each executing part of a job provided in the MFP 1 are implemented. That is, one job is expressed by combining components in the function implementation part 30. In this embodiment, each component is referred to as a “filter.” This is because the software architecture is based on an architecture called “pipes and filters” in the case of implementing a part to execute a job of the MFP 1 with software.

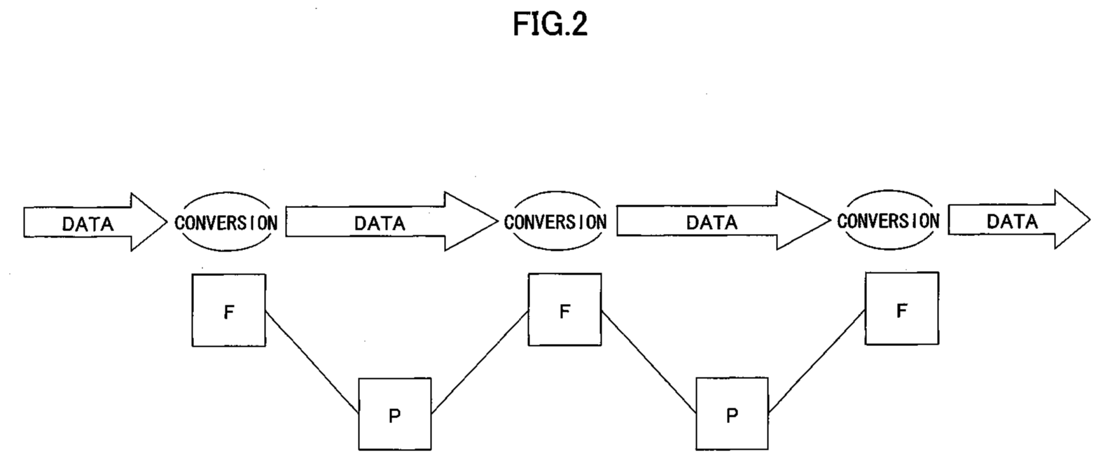

FIG. 2 is a diagram for illustrating the concept of the pipes and filters architecture according to one embodiment of the present invention.

In FIG. 2, “F” shows a filter and “P” shows a pipe. As shown in FIG. 2, filters are connected with pipes. Each filter converts input data, and outputs the result of the conversion. Each pipe communicates the output data of a filter to the next filter.

In the MFP 1 according to this embodiment, each function is taken as a succession of conversions of a document (data). An MFP job can be generalized as being configured of inputting, processing, and outputting a document. Here, “inputting,” “processing,” and “outputting” are taken as “conversions,” and a software component that implements one “conversion” is configured as a filter. Each filter is independent, and basically, there is no dependency (calling relationship) between filters. Accordingly, it is possible to perform addition (installation) or deletion (uninstallation) on a filter-by-filter basis.

Referring back to FIG. 1, the function implementation part 30 includes, for example, an image obtaining filter 301, a stored document reading filter 302, a mail reception filter 303, a facsimile (FAX) reception filter 304, a reception filter 305, and a report filter 306 as filters that implement inputting.

The image obtaining filter 301 controls reading of image data by a scanner, and outputs the read image data. The stored document reading filter 302 reads document data (image data) stored in a storage unit of the MFP 1, and outputs the read data. The mail reception filter 303 receives electronic mail (e-mail) and outputs data contained in the electronic mail. The facsimile reception filter 304 controls facsimile reception and outputs received printing data. The reception filter 305 outputs image data received from another (external) image processor through a communications part 52 of the device part 50. The report filter 306 outputs the setting information and the history information of the MFP 1 as, for example, tabular data.

The function implementation part 30 further includes a document processing filter 311 and a document conversion filter 312 as filters that implement image data processing. The document processing filter 311 performs predetermined image conversion (such as combining, enlargement, or reduction) on input data, and outputs the input data. The document conversion filter 312 converts the data format of image data. The document conversion filter 312, for example, performs rendering, that is, converts input PostScript data into bitmap data and outputs the bitmap data.

The function implementation part 30 further includes an image forming filter 321, a stored document storage filter 322, a mail transmission filter 323, a facsimile (FAX) transmission filter 324, a slave unit output filter 325, and a preview filter 326 as filters that implement outputting.

The image forming filter 321 causes a plotter to output (print) input data. The stored document storage filter 322 stores input data in a storage unit such as a hard disk unit inside the MFP 1. The mail transmission filter 323 transmits input data as an attachment to electronic mail. The facsimile transmission filter 324 transmits input data by facsimile. The slave unit output filter 325 outputs input data to another image processor. The preview filter 326 causes input data to be displayed on the operations panel (not graphically illustrated) as a preview through the local UI part 11.

The function implementation part 30 further includes a linked printing filter 313 as a filter that implements a linkage function. The linked printing filter 313 implements linked printing by distributing a print job between the image forming filter 321 and the slave unit output filter 325.

The device service part 40, where lower-level functions used in common by the filters of the function implementation part 30 are implemented, includes a data management part 41 and a slave unit list retention part 42. The data management part 41 represents or contains various databases such as a database with which user information is registered and a database in which document or image data are stored. The slave unit list retention part 42 retains a list of other image processors to serve as candidate slave units at the time of performing linked printing, which list includes the identification information and the specifications of the other image processors.

The device part 50 includes devices provided for the corresponding devices of the MFP 1 and parts that control the devices. The device part 50 includes, for example, an image forming part 51, the communications part 52, and an image input part 53.

(Functional Configuration of MFP 1)

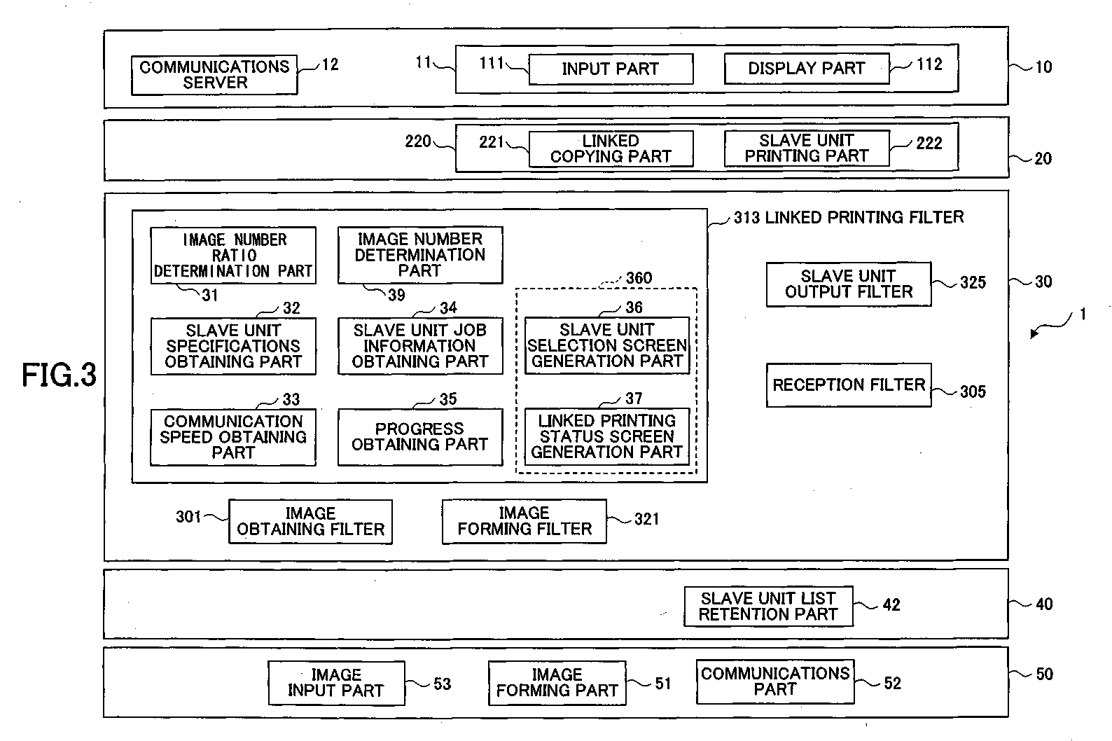

FIG. 3 is a block diagram showing a functional configuration of the MFP 1, which is an image processor according to one embodiment of the present invention.

Of the parts described with reference to FIG. 1, those related to a linkage function are described in detail with reference to FIG. 3, and a description of the other parts is omitted.

Referring to FIG. 3, the user interface part 10 includes the local UI part 11 and the communications server part 12. The local UI part 11 includes an input part 111 and a display part 112. The input part 111 is where job instructions are input. The display part 112 displays the status of the MFP 1. The communications server 12 performs communications with other image processors, and outputs a job instruction received from another image processor to a filter of the function implementation part 30 corresponding to the job through the control part 20.

The control part 20 includes the linked copying part 221 or the slave unit printing part 222.

The linked copying part 221 implements the function of linked copying by outputting image data obtained by the image obtaining filter 301 to the linked printing filter 313.

The slave unit printing part 222 implements the function of a slave unit of linked printing by outputting image data received by the reception filter 305 to the image forming filter 321.

In the case where the MFP 1 has the function of a master unit of linked printing, it is satisfactory if the MFP 1 has the linked copying part 221, and in the case where the MFP 1 has the function of a slave unit of linked printing, it is satisfactory if the MFP 1 has the slave unit printing part 222.

The function implementation part 30 includes the linked printing filter 313, the slave unit output filter 325, the image obtaining filter 301, the image forming filter 321, and the reception filter 305.

In the case where the MFP 1 has the function of a master unit of linked printing, it is satisfactory if the MFP 1 has the linked printing filter 313, the image forming filter 321, and the slave unit output filter 325. In the case where the MFP 1 has the function of a master unit of linked copying, it is satisfactory if the MFP 1 has the image obtaining filter 301 in addition to the filters that implements the function of a master unit of linked printing.

Further, in the case where the MFP 1 has the function of a slave unit of linked printing, it is satisfactory if the MFP 1 has the image forming filter 321 and the reception filter 305.

The “master unit” refers to an image processor that gives an instruction to execute a job, and the “slave unit” refers to an image processor that executes a job based on an instruction from another image processor.

(Description of Filters Implementing Function of Master Unit)

The linked printing filter 313 implements the function of a master unit of linked printing. The linked printing filter 313 implements linked printing by dividing an input print job between the image forming filter 321 and the slave unit output filter 325. The linked printing filter 313 includes an image number ratio determination part 31 and an image number determination part 39. The linked printing filter 313 may further include a slave unit specifications obtaining part 32, a communication speed obtaining part 33, a slave unit job information obtaining part 34, a progress obtaining part 35, a slave unit selection screen generation part 36, and a linked printing status screen generation part 37.

The image number ratio determination part 31 determines the ratio of the number of images to be formed by the image forming part 51 of the MFP 1 to the number of images to be formed by a slave unit at the time of performing linked printing. The image number ratio determination part 31 determines the image number ratio based on, for example, the ratio of the image forming speed of the image forming part 51 (the speed at which the image forming part 51 forms an image) to the image forming speed of the slave unit (the speed at which the slave unit forms an image). Alternatively, the image number ratio determination part 31 may determine the image number ratio based on, for example, the communication speed of communications with the slave unit.

Alternatively, the image number ratio determination part 31 may also determine the image number ratio based on, for example, the progress of a print job in the image forming part 51 and the slave unit while the print job is in progress. The progress of a print job may be the number of media such as sheets of paper on which an image is formed, which number is obtained every time the image is formed on a medium. Alternatively, the progress of a job may be information that reports interruption of processing in the image forming part 51 or the slave unit due to a jam.

The image number determination part 39 determines the number of images for each of image processors that implement a linked job based on the image number ratio determined by the image number ratio determination part 31 and the total number of images to be output according to a job instruction from the input part 111. The image number ratio determination part 31 and the image number determination part 39 may be configured as a single part.

The slave unit specifications obtaining part 32 obtains the specifications of an image processor that is a candidate slave unit of linked printing. The slave unit specifications obtaining part 32 obtains, for example, the image forming speed (speed at which an image is formed) of an image processor that is a candidate slave unit. The slave unit specifications obtaining part 32 may also make a request to an image processor that is a candidate slave unit for information on its image forming speed through the communications part 52. Further, the slave unit specifications obtaining part 32 may also obtain information on the image forming speed of each candidate slave unit from the slave unit list of the MFP 1, which is a list of candidate slave units.

The communication speed obtaining part 33 obtains the communication speed between the MFP 1 and an image processor that is a slave unit or candidate slave unit of linked printing. The communication speed obtaining part 33 may obtain the communication speed through the communications part 52.

The slave unit job information obtaining part 34 obtains information on the job status of an image processor that is a candidate slave unit of linked printing. The information on the job status may be, for example, the total number of jobs that are being and waiting to be executed by the candidate slave unit or a period of waiting before a job of linked printing is executable after all of the jobs being executed and waiting to be executed are finished. The slave unit job information obtaining part 34 makes a request to the candidate slave unit for information on its job status through the communications part 52.

The progress obtaining part 35 obtains (information on) the (status of) progress of a linked job of the image forming part 51 and/or a slave unit. The progress obtaining part 35 obtains, for example, the number of media or sets of media (copies) having an image or images formed thereon. Further, if the image forming part 51 or the slave unit stops forming images because of a jam, the progress obtaining part 35 may also obtain information on it.

The slave unit selection screen generation part 36 generates a slave unit list that is a list of candidates slave units retained in the slave unit retention part 42, and further generates a slave unit selection screen for selecting a slave unit. The slave unit selection screen generation part 36 generates a screen that contains the identification information of candidate slave units retained in the slave unit list retention part 42. The slave unit selection screen generation part 36 creates, for example, a screen that displays candidate slave units in order of decreasing image forming speed based on their image forming speeds. Alternatively, the slave unit selection screen generation part 36 may create, for example, a screen that displays candidate slave units in order of increasing waiting period. Further, the slave unit selection screen may include a field for selecting an image processor to be used as a slave unit from candidate slave units.

The linked printing status screen generation, part 37 generates a screen that displays the progress of a job of linked printing in master and slave units. If there are multiple slave units, the screen displays the progress of a job with respect to each slave unit. For example, the linked printing status screen generation part 37 may display the identification information of the master and slave units in decreasing order of their job progress speeds. Alternatively, the linked printing status screen generation part 37 may display the identification information of the master and slave units in increasing order of their job progress speeds. Further, the linked printing status screen may include a field for changing the distribution of a job between the master and slave units or a field for giving an instruction to display a screen for changing the distribution of a job between the master and slave units.

The slave unit selection screen generation part 36 and/or the linked printing status screen generation part 37 may be configured as a linked printing user interface filter separately from the linked printing filter 313.

The slave unit output filter 325 outputs a job including input image data to a slave unit at the time of performing linked printing.

The linked printing filter 313 may have image data input thereto not only from the image obtaining filter 301 by the linked copying part 221 but also from a filter that obtains the image data of an image input via a network. In addition, the image data contained in a storage unit of the MFP 1 may also be input to the linked printing filter 313. This enables linked printing to be performed from various image data input modes or retention modes of the MFP 1.

The reception filter 305 receives a job from a master unit when the MFP 1 serves as a slave unit of linked printing.

The image obtaining filter 301 obtains an image input from, for example, the image input part 53 such as a scanner. The image forming filter 321 outputs image data to the image forming part 51 such as a plotter.

(Description of Device Service Part and Device Part)

The device service part 40 includes the slave unit list retention part 42. The slave unit list retention part 42 retains information such as the identification information of other image processors that are candidate slave units. Candidate slave units are, for example, image processors connected to the MFP 1 directly or via a network. The identification information of candidate slave units is, for example, input from the input part 111 to be retained in the slave unit list retention part 42. The slave unit list retention part 42 may further retain the specifications of candidate slave units. The specifications of candidate slave units may be, for example, image forming speed. This enables the slave unit selection screen generation part 36 to generate a screen that displays candidate slave units based on the image forming speeds of the candidate slave units.

The device part 50 includes, for example, the image forming part 51, the communications part 52, and the image input part 53. The image forming part 51 includes an apparatus that forms an image, such as a plotter, and a part that controls the apparatus. The communications part 52 includes, for example, a network interface. The image input part 53 includes, for example, an apparatus that inputs an image, such as a scanner, and a part that controls the apparatus.

(Example Connection of Image Processors Implementing Linked Copying)

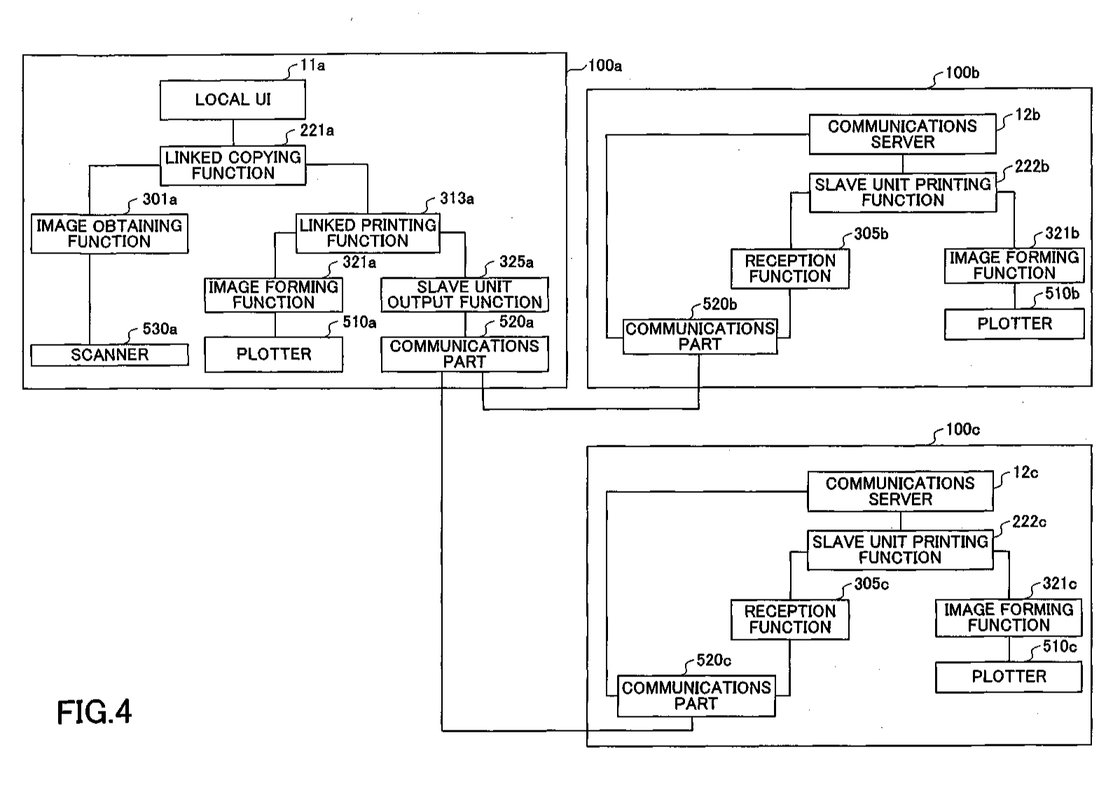

FIG. 4 is a diagram showing an example connection of image processors that implements linked copying according to one embodiment of the present invention.

In FIG. 4, an MFP 100b and an MFP 100c to serve as slave units of linked copying are connected to an MFP 100a to serve as a master unit of linked copying.

The MFP 100a includes a local UI 11a, a linked copying function 221a, an image obtaining function 301a, a linked printing function 313a, an image forming function 321a, a slave unit output function 325a, a scanner 530a, a plotter 510a, and a communications part 520a. The MFP 100a implements a linked copying function by connecting and controlling the scanner 530a, the plotter 510a, and the communications unit 520a, which are devices, with a filter that implements the linked copying function.

The MFP 100b includes a communications server 12b, a slave unit printing function 222b, a reception function 305b, an image forming function 321b, a communications part 520b, and a plotter 510b. The MFP 100b implements a slave unit function of linked copying by connecting and controlling the plotter 510b and the communications part 520b, which are devices, with a filter that implements the slave unit function of linked copying. In more detail, the communications server 12b outputs a job of a slave unit of linked copying to the slave unit printing function 222b based on information received by the communications part 520b, and based on this, the reception function 305b outputs received image data to the image forming function 321b so as to cause the plotter 510b to form an image on a medium.

The MFP 100c has the same configuration and functions as the MFP 100b, and a description thereof is therefore omitted.

(Sequence of Slave Unit Selection Screen Generation)

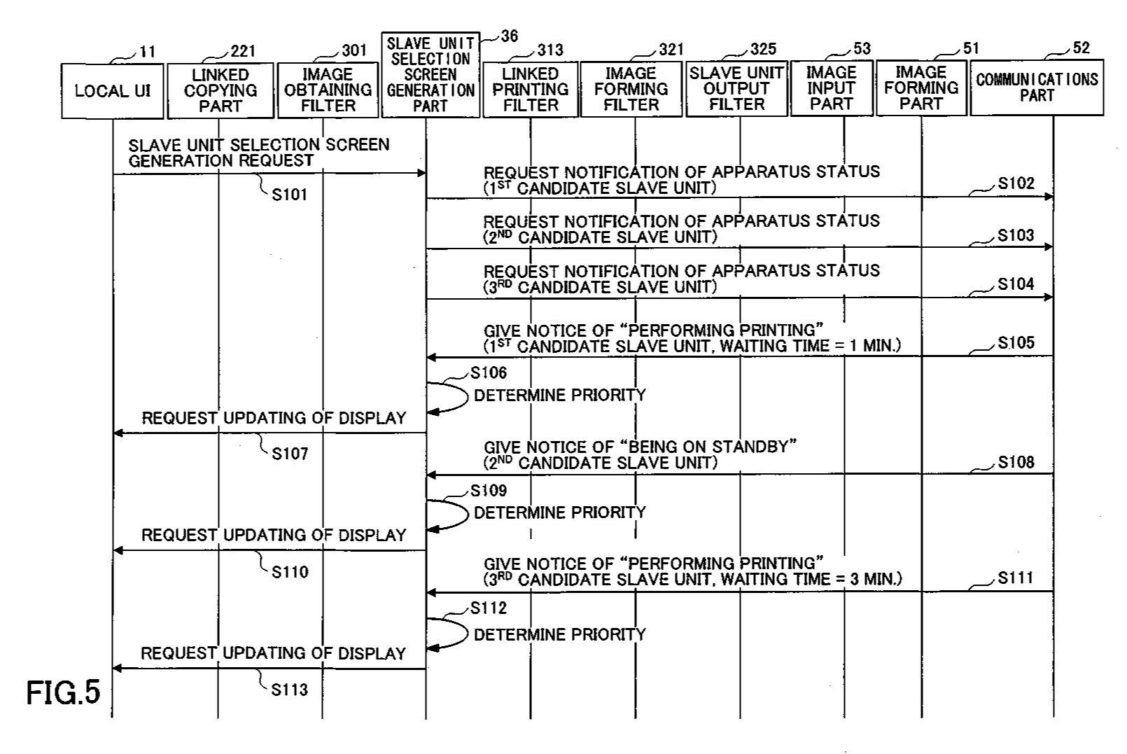

FIG. 5 is a diagram showing a sequence of generating a slave unit selection screen that displays candidate slave units according to one embodiment of the present invention.

In the case of FIG. 5, a slave unit selection screen is displayed on the display part 112 of the local UI part 11 based on an instruction input from the input part 111 of the local UI part 11.

Referring to FIG. 5, in step S101, a request to generate a slave unit selection screen (a slave unit selection screen generation request) is output from the local UI part 11 to the slave unit selection screen generation part 36 of the linked printing filter 313. The slave unit selection screen generation request may contain information on candidate slave units. The information on candidate slave units may be, for example, the identification information of image processors that are candidate slave units. The slave unit selection screen generation part 36 obtains the information on candidate slave units based on step S101. The slave unit selection screen generation part 36 may obtain the information on candidate slave units from either the slave unit selection screen generation request or the information retained by the slave unit list retention part 42.

After step S101, steps S102, S103, and S104 are performed. In step S102, the slave unit selection screen generation part 36 outputs an apparatus status notification request to the image processor of a first candidate slave unit through the communications part 52. In step S103, the slave unit selection screen generation part 36 outputs an apparatus status notification request to the image processor of a second candidate slave unit through the communications part 52. In step S104, the slave unit selection screen generation part 36 outputs an apparatus status notification request to the image processor of a third candidate slave unit through the communications part 52. Steps S102 through S104 may be performed asynchronously.

In step S105 subsequent to step. S102, the slave unit selection screen generation part 36 is notified by the first candidate slave unit through the communications part 52 that the first candidate slave unit is performing printing. The information obtained from the first candidate slave unit indicates, for example, that the waiting time is 1 minute.

Next, in step S106, the slave unit selection screen generation part 36 determines the order of priority in displaying the candidate slave units. In step S106, since only the status of the first candidate slave unit has been obtained, a slave unit selection screen containing information on the first candidate slave unit is generated.

Next, in step S107, the slave unit selection screen generation part 36 outputs to the local UI part 11 a display update request or a request to display the slave unit selection screen generated in step S106. Then, the local UI part 11 updates the display based on step S107.

In step S108 subsequent to step S103, the slave unit selection screen generation part 36 is notified by the second candidate slave unit through the communications part 52 that the second candidate slave unit is in a standby state.

Next, in step S109, the slave unit selection screen generation part 36 determines the order of priority in displaying the candidate slave units. In step S109, since the statuses of the first and second candidate slave units have been obtained, a slave unit selection screen containing the first and second candidate slave units is generated. The slave unit selection screen generation part 36 generates the slave unit selection screen based on, for example, the job statuses of the candidate slave units. In more detail, since the second candidate slave unit is in the standby state and the first candidate slave unit is performing printing, the slave unit selection screen generation part 36 generates the slave unit selection screen so that the identification information of the second candidate slave unit precedes the identification information of the first candidate slave unit.

Next, in step S110, the slave unit selection screen generation part 36 outputs to the local UI part 11 a display update request or a request to display the slave unit selection screen generated in step S109. Then, the local UI part 11 updates the display based on step S110.

In step S111 subsequent to step S104, the slave unit selection screen generation part 36 is notified by the third candidate slave unit through the communications part 52 that the third candidate slave unit is performing printing. The information obtained from the third candidate slave unit indicates, for example, that the third candidate slave unit has two jobs waiting to be executed in addition to the job in execution and the waiting time is 3 minutes.

Next, in step 112, the slave unit selection screen generation part 36 determines the order of priority in displaying the candidate slave units. In step S112, since the statuses of the first through third candidate slave units have been obtained, a slave unit selection screen containing the first through third candidate slave units is generated. The slave unit selection screen generation part 36 generates the slave unit selection screen based on, for example, the job statuses of the candidate slave units. In more detail, since the second candidate slave unit is in a standby state, the waiting time of the first candidate slave unit is 1 minute, and the waiting time of the third candidate slave unit is 3 minutes, the slave unit selection screen generation part 36 generates the slave unit selection screen so that the second candidate slave unit is at the top of the display, followed by the first candidate slave unit and the third candidate slave unit in this order.

The slave unit selection screen may contain the image forming speeds of the candidate slave units in addition to their statuses. Further, the identification information of the candidate slave units may be displayed in decreasing order of their image forming speeds.

Further, the slave unit selection screen is updated and displayed every time information on a candidate slave unit is obtained.

(Example of Slave Unit Selection Screen)

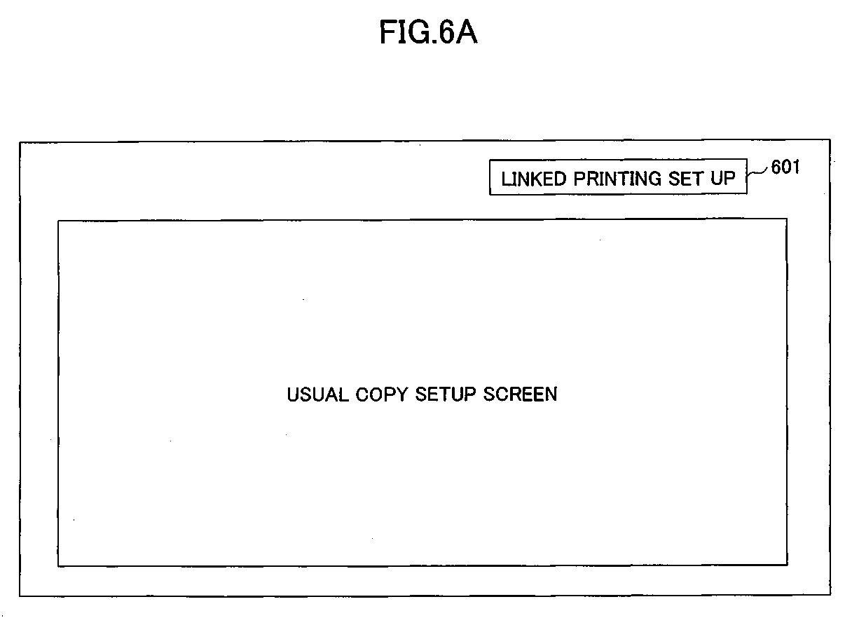

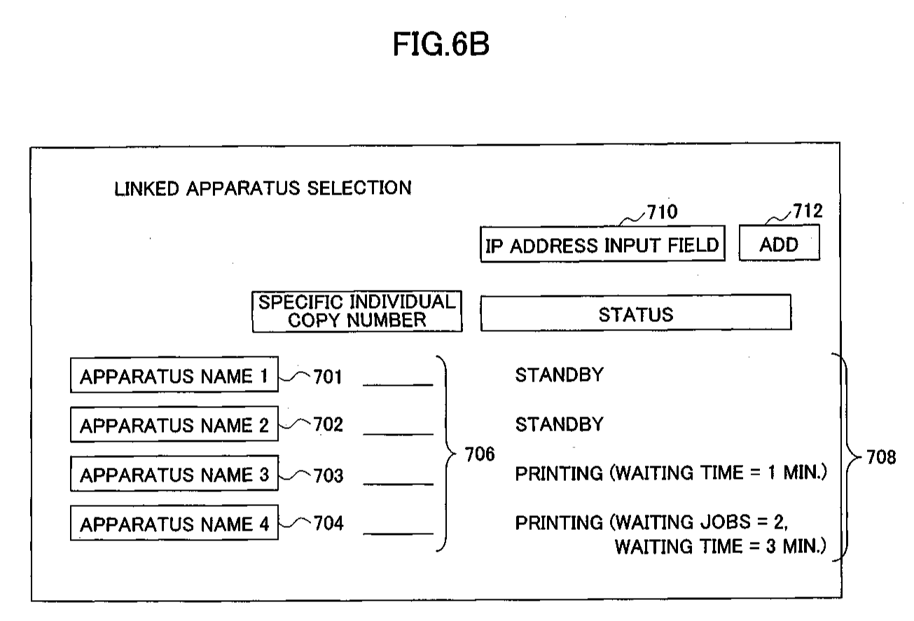

FIGS. 6A and 6B are diagrams for illustrating a slave unit selection screen displayed on the local UI part 11 by the processing of FIG. 5 according to one embodiment of the present invention.

In FIG. 6A, a usual copy setup screen is displayed with a button 601 for giving an instruction for LINKED PRINTING SETUP. The transition of state to displaying a slave unit selection screen is caused by an operator pressing the LINKED PRINTING SETUP button 601. FIG. 6B is a diagram showing a slave unit selection screen. In FIG. 6B, buttons 701, 702, 703, and 704 of APPARATUS NAME 1 through APPARATUS NAME 4 as candidate slave units are displayed. By the operator selecting a button corresponding to an apparatus, a candidate slave unit corresponding to the button is selected as a slave unit.

Each of the buttons 701 through 704 of APPARATUS NAME 1 through APPARATUS NAME 4 has a corresponding SPECIFIC INDIVIDUAL COPY NUMBER field 706 AND STATUS field 708 provided therefor. The SPECIFIC INDIVIDUAL COPY NUMBER field 706 is where the operator inputs the number of copies (sets of media) in the case of specifying the number of copies to be output with respect to each of image processors selected as slave units. If no number of copies is input to the SPECIFIC INDIVIDUAL COPY NUMBER field 706, the image number ratio determination part 31 of the linked printing filter 313 determines the number of images formed by each of the master and slave units. According to the image processor of this embodiment, the “number of media (for example, sheets of paper) may be input to the SPECIFIC INDIVIDUAL COPY NUMBER field 706 in place of inputting the “number of copies” thereto. That is, the “number of sheets” on which an image is to be formed may be specified instead of specifying the “number of copies” each formed of multiple sheets of images.

The STATUS field 708 is where the status of a candidate slave unit is displayed. For example, waiting time may be displayed in addition to job statuses such as STANDBY and PRINTING.

Further, in the case of selecting an image processor other than those displayed in APPARATUS NAME 1 through APPARATUS NAME 4, the image processor can be added as a slave unit by inputting the IP address of the image processor in an IP ADDRESS INPUT FIELD 710 serving as an identification information input field and pressing an ADD button 712. The identification information input field may be so designed that information other than the IP address, which information identifies the image processor, may be input thereto.

(Sequence Diagram of Processing in Case of Sort Printing [Master Unit])

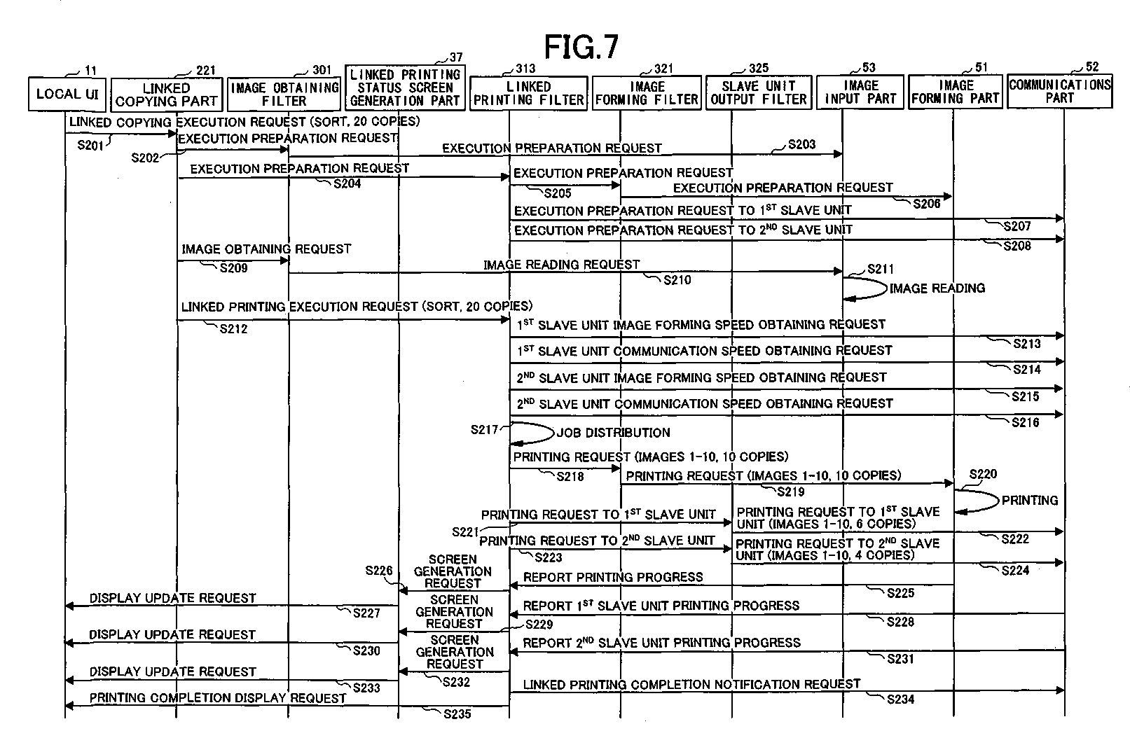

FIG. 7 is a sequence diagram illustrating processing in the case of performing sort printing by linked printing according to one embodiment of the present invention.

In the case of FIG. 7, the linked printing function executes processing to output 20 copies, each formed of 10 sheets of images, by sort printing based on a linked copying instruction input from the local UI part 11.

Sort printing is a printing method that successively outputs multiple images copy by copy from an image processor in the case of forming the multiple images on media different from each other.

Referring to FIG. 7, in step S201, a request to execute linked copying (a linked copying execution request) is output from the local UI part 11 to the linked copying part 221. The linked copying execution request may contain, for example, information showing “sort” as an output mode and “20” as the number of copies. Next, in step S202, a request to prepare for execution of linked copying (a linked copying execution preparation request) is output from the linked copying part 221 to the image obtaining filter 301. In step S203, a linked copying execution preparation request is output from the image obtaining filter 301 to the image input part 53. Preparations are made for image reading in linked copying through the processing of steps S202 and S203.

On the other hand, simultaneously with or before or after (that is, asynchronously with) step S202, in step S204 subsequent to step S201, a linked copying execution preparation request is output from the linked copying part 221 to the linked printing filter 313. The execution preparation request output from the linked copying part 221 is based on a job of linked copying, but may be an execution preparation request for linked printing because the function implemented by the linked printing filter 313 is the same as linked printing.

Next, in step S205 after step S204, a linked printing execution preparation request is output from the linked printing filter 313 to the image forming filter 321. Next, in step S206, a linked printing execution preparation request is output from the image forming filter 321 to the image forming part 51.

Simultaneously with or before or after (that is, asynchronously with) step S205, in step S207 subsequent to step S204, a linked printing execution preparation request is output from the linked printing filter 313 to a first slave unit through the communications part 52. Simultaneously with or before or after (that is, asynchronously with) step S207, in step S208 subsequent to step S204, a linked printing execution preparation request is output from the linked printing filter 313 to a second slave unit through the communications part 52.

Preparations for execution of the job of linked copying are made through the processing of steps S202 through S208.

Next, in step S209, a request to obtain an image (an image obtaining request) is output from the linked copying part 221 to the image obtaining filter 301. Next, in step S210, a request to read an image (an image reading request) is output from the image obtaining filter 301 to the image input part 53. Next, in step S211, the image input part 53 optically reads an image formed on a medium, and obtains image data. The image data obtained by the image input part 53 may be converted into a predetermined format by the image obtaining filter 301. As a result, the format of image data to be processed can be unified between or among multiple filters of the image processor according to this embodiment of the present invention, thus making it possible to facilitate addition and deletion of filters.

Next, in step S212, a request to execute linked printing (a linked printing execution request) is output from the linked copying part 221 to the linked printing filter 313. The linked printing execution request may contain, for example, information showing “sort” as a mode of outputting media and “20” as the number of copies to be output.

Next, the processing proceeds to steps S213 and S215 after step S212. In step S213, the slave unit specifications obtaining part 32 of the linked printing filter 313 makes a request to the first slave unit for information on its image forming speed through the communications part 52. On the other hand, in step S215, the slave unit specifications obtaining part 32 of the linked printing filter 313 makes a request to the second slave unit for information on its image forming speed through the communications part 52.

If the slave unit list retention part 42 retains the image forming speed of a slave unit as one of its specifications, the slave unit specifications obtaining part 32 may obtain information retained by the slave unit list retention part 42 instead of making a request to the slave unit for information on its image forming speed. This makes it possible to obtain information on the slave unit faster and more easily than through communications between the master unit and the slave unit.

Next, in step S214 after step S213, the communication speed obtaining part 33 of the linked printing filter 313 makes a request to the communications part 52 for information on the speed of communications with the first slave unit. On the other hand, in step S216 after step S215, the communication speed obtaining part 33 of the linked printing filter 313 makes a request to the communications part 52 for information on the speed of communications with the second slave unit.

In response to the requests for the image forming speed information and the communication speed information in steps S213 through S216, the first slave unit, the second slave unit, and the communications part 52 output corresponding information, which is obtained by the linked printing filter 313.

Next, in step S217, the image number ratio determination part 31 of the linked printing filter 313 obtains the ratio of the number of images to be formed by the image forming part 51, the first slave unit, and the second slave unit, respectively. The image number ratio may be determined based on, for example, their respective image forming speeds or the speeds of communications with the first and second slave units. The image number determination part 39 determines the number of images to be output with respect to each of the master unit, the first slave unit, and the second slave unit based on the image number ratio determined by the image number ratio determination part 31.

For example, in the case of printing 20 copies by sort printing on condition that the master unit has an image forming speed of 44 ppm (pages per minute), and each of the first and second slave units has an image forming speed of 38 ppm, the number of copies to be made by the master unit NCm can be given by Eq. (1) as follows:

NCm=(44/(44+38+38))*20≈7(copies). (1)

In the case of FIG. 7, 20 copies are distributed among the master unit, the first slave unit, and the second slave unit so that the master unit is assigned ten copies, the first slave unit is assigned six copies, and the second slave unit is assigned four copies.

Equation (1) determines the number of copies to be made by each of the master unit and the first and second slave units so that the master unit and the first and second slave units finish their respective print jobs simultaneously or as near to simultaneously as possible. Equation (1) does not perform adjustment in terms of communications speed. However, for example, if the speed of communications with the first or second slave unit is lower than a predetermined value, the number of copies to be assigned to the image processor (slave unit) may be reduced and the reduction may be assigned to another image processor. This makes it possible to execute a job of linked printing with efficiency.

After step S217, the processing of steps S218 through S224 is performed. In step S218, a request for printing (a printing request) is output from the linked printing filter 313 to the image forming filter 321. The printing request contains, for example, image data 1 to 10 for the first through 10^{th} sheets (media), respectively, and information of “10,” which shows the number of copies. Next, in step S219, a printing request is output from the image forming filter 321 to the image forming part 51. In step S220, the image forming part 51 performs the processing of forming an image.

Simultaneously with or before or after (that is, asynchronously with) step S218, in step S221 subsequent to step S217, a printing request to the first slave unit is output from the linked printing filter 313 to the slave unit output filter 325. Next, in step S222, a printing request is output from the slave unit output filter 325 to the first slave unit through the communications part 52. The printing request to the first slave unit contains, for example, the image data 1 to 10 and information of “6,” which shows the number of copies.

Simultaneously with or before or after (that is, asynchronously with) step S218, in step S223 subsequent to step S217, a printing request to the second slave unit is output from the linked printing filter 313 to the slave unit output filter 325. Next, in step S224, a printing request is output from the slave unit output filter 325 to the second slave unit through the communications part 52. The printing request to the second slave unit contains, for example, the image data 1 to 10 and information of “4,” which shows the number of copies.

By the above-described processing of steps S218 through S224, the printing requests are output to the image forming part 51, the first slave unit, and the second slave unit, and image forming is started.

In subsequent steps S225 and S233, a screen showing the progress of the job is displayed and updated. Steps S225, S228, and S231 may be asynchronously performed.

In step S225, the image forming part 51 notifies the progress obtaining-part 35 of the linked printing filter 313 of the progress of the print job. Next, in step S226, a request to generate a screen that shows the progress of a job is output from the progress obtaining part 35 to the linked printing status screen generation part 37. The linked printing status screen generation part 37 generates a screen that shows the progress of the print job based on step S226. Next, in step S227, the screen showing the progress of the print job and a request to update a display screen are output from the linked printing status screen generation part 37 to the local UI part 11. The local UI part 11 updates a screen to display on the display part 112 based on step S227.

In step S228, the communications part 52 notifies the progress obtaining part 35 of the linked printing filter 313 of the progress of the print job received from the first slave unit. Next, in step S229, a request to generate a screen that shows the progress of a job is output from the progress obtaining part 35 to the linked printing status screen generation part 37. The linked printing status screen generation part 37 newly generates a screen that shows the progress of the print job based on step S229. Here, a screen that shows the progress of the print job including the status of the print job of the image forming part input in step S226 and the status of the print job of the first slave unit is generated. Next, in step S230, the screen showing the progress of the print job and a request to update a display screen are output from the linked printing status screen generation part 37 to the local UI part 11. The local UI part 11 updates a screen to display on the display part 112 based on step S230.

In step S231, the communications part 52 notifies the progress obtaining part 35 of the linked printing filter 313 of the progress of the print job received from the second slave unit. Next, in step S232, a request to generate a screen that shows the progress of a job is output from the progress obtaining part 35 to the linked printing status screen generation part 37. The linked printing status screen generation part 37 newly generates a screen that shows the progress of the print job based on step S232. Here, a screen that shows the progress of the print job including the status of the print job of the image forming part input in step S226, the status of the print job of the first slave unit input in step S229, and the status of the print job of the second slave unit is generated. Next, in step S233, the screen showing the progress of the print job and a request to update a display screen are output from the linked printing status screen generation part 37 to the local UI part 11. The local UI part 11 updates a screen to display on the display part 112 based on step S233.

In steps S225 through S233, the processing related to the image forming part 51, the processing related to the first slave unit, and the processing related to the second slave unit are asynchronously performed. Every time the progress of the print job is obtained, the screen displayed on the local UI part 11 is updated.

The processing of steps S225 through S233 is repeated while image forming is performed. Further, each of the image forming part 51, the first slave unit, and the second slave unit reports the progress of the print job every time an image is formed on one medium.

After the linked printing filter 313 is notified of completion of the entire print job, in step S234, a linked printing completion notification request or a request to notify the first and second slave units of completion of the entire print job is output from the linked printing filter 313 to the communications part 52. Next, in step S235, a printing completion display request or a request to display information indicating completion of printing is output from the linked printing filter 313 to the local UI part 11, and the local UI part 11 displays information indicating completion of printing on the display part 112 based on the request.

(Job Progress Display Screen)

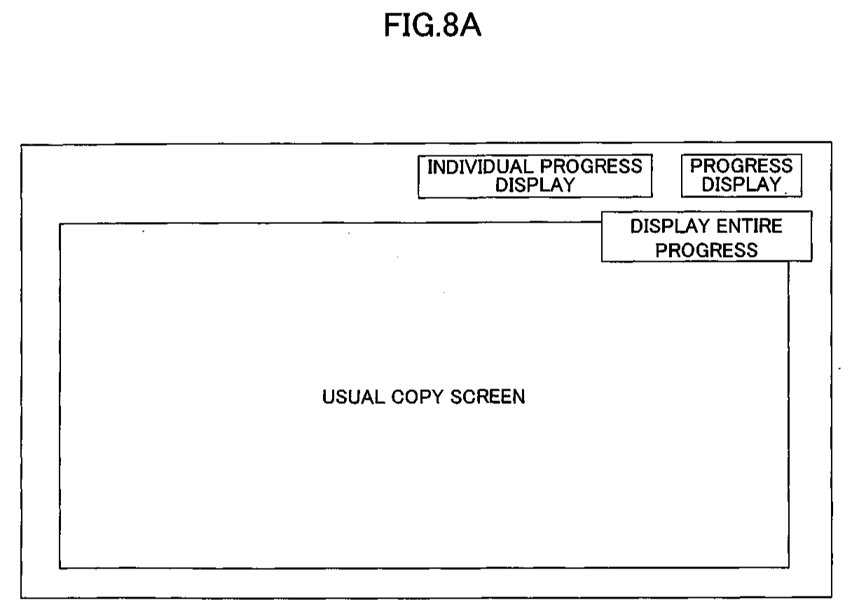

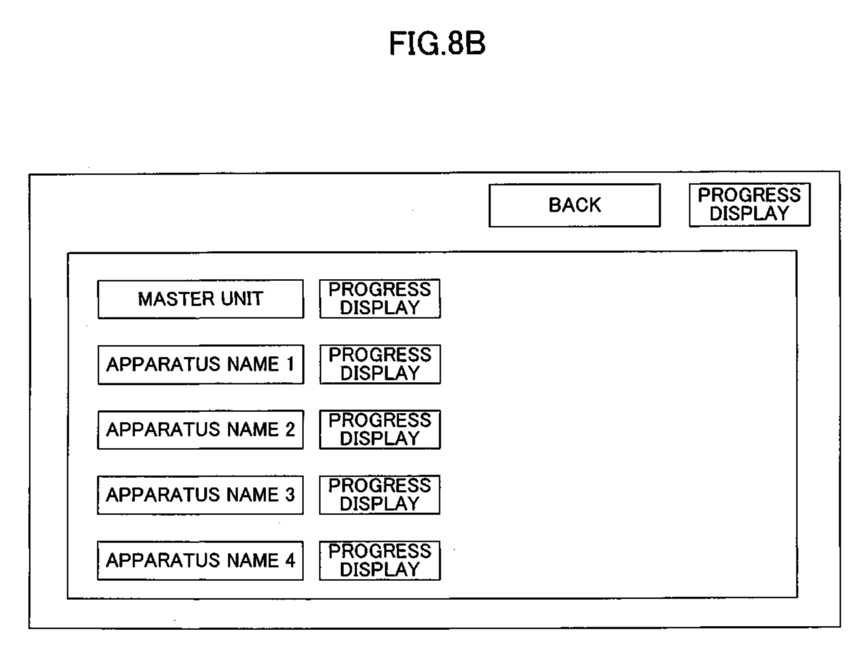

FIGS. 8A and 8B are diagrams for illustrating a screen that displays job progress (a job progress display screen) according to one embodiment of the present invention.

FIG. 8A shows a screen that displays the progress of the entire job substantially the same as in the case of usual copying. On the screen of FIG. 8A, for example, the total number of images or copies to be formed is displayed. The screen of FIG. 8A further includes an INDIVIDUAL PROGRESS DISPLAY button. By an operator pressing the INDIVIDUAL PROGRESS DISPLAY button, the screen shown in FIG. 8B is displayed.

FIG. 8B shows a screen that displays the progress of a job of linked printing. The screen displays the progress of the job in each of a master unit and slave units. The screen of FIG. 8B contains displays of MASTER UNIT and APPARATUS NAME 1 through APPARATUS NAME 4 corresponding to the master unit and the slave units, respectively, and PROGRESS DISPLAY buttons corresponding to the displays. When the operator presses any of the PROGRESS DISPLAY buttons, the progress of the print job in a corresponding one of the master unit and the slave units is displayed.

Instead of the screen shown in FIG. 5B, the job progress display screen may display a list of the statuses of the progress of the print job in the master unit and the slave units in response to pressing the INDIVIDUAL PROGRESS DISPLAY button on the screen of FIG. 8A.

Further, the job progress display screen may contain, for example, a linked printing change input field for inputting the number of outputs such as copies to be newly assigned in the case of redistributing a job because of occurrence of a jam or depending on the progress of the job in each image processor.

(Sequence Diagram of Processing in Case of Sort Printing [Slave Unit])

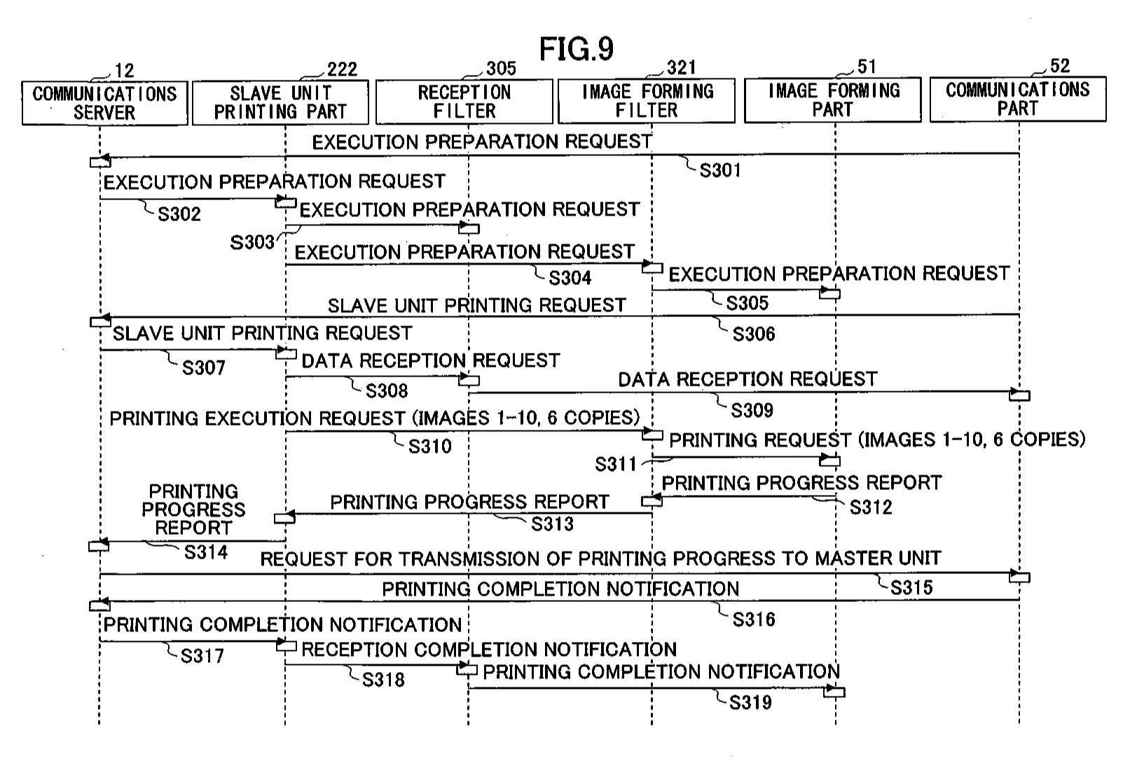

FIG. 9 is a sequence diagram illustrating processing in a slave unit in the case of performing sort printing by linked printing according to one embodiment of the present invention.

In the case of FIG. 9, the image forming part 51 of the slave unit executes a print job based on the communications server 12 obtaining a job instruction from a master unit.

Referring to FIG. 9 along with FIG. 4, in step S301, a request to prepare for execution of a job (print job) of linked printing received from a master unit by the communications part 52 (a linked printing job execution preparation request) is output from the communications part 52 to the communications server 12. The job execution preparation request received by the communications part 52 may be, for example, the linked printing execution preparation request output from the linked printing filter 313 of the master unit in step S207 or S208 of FIG. 7.

Next, in step S302, a linked printing job execution preparation request is output from the communications server 12 to the slave unit printing part 222. Next, in step S303, a linked printing job execution preparation request is output from the slave unit printing part 222 to the reception filter 305, so that preparations are made to receive data from the master unit.

On the other hand, simultaneously with or before or after (that is, asynchronously with) step S303, in step S304, a linked printing job execution preparation request is output from the slave unit printing part 222 to the image forming filter 321. Next, in step S305, a linked printing job execution preparation request is output from the image forming filter 321 to the image forming part 51. The image forming part 51 prepares for execution of a print job based on step S305.

Preparations are made to execute a job of linked printing through the above-described processing of steps S301 through S305.

Next, in step S306, a request to execute the job of slave unit printing received from the master unit by the communications part 52 (a slave unit printing job execution request) is output from the communications part 52 to the communications server 12. The slave unit printing job execution request may be, for example, the printing request transmitted from the communications part 52 of the master unit based on step S222 of FIG. 7.

Next, in step S307, a slave unit printing job execution request is output from the communications server 12 to the slave unit printing part 222. Next, in step S308, a request to receive image data transmitted from the master unit is output from the slave unit printing part 222 to the reception filter 305. Next, in step S309, a request to receive image data transmitted from the master unit is output from the reception filter 305 to the communications part 52. The communications part 52 receives image data from the master unit based on step S309, and stores the image data in a storage unit (not graphically illustrated) of the slave unit.

Next, in step S310, a request to execute slave unit printing (a slave unit printing execution request) is output from the slave unit printing part 222 to the image forming filter 321. The slave unit printing execution request contains, for example, image data and information of “6” showing the number of copies received in step S309.

Next, in step S311, a slave unit printing execution request is output from the image forming filter 321 to the image forming part 51. The image forming part 51 forms and outputs images on media based on step S311.

The processing may proceed to step S310 after all the image data are received in step S309. Alternatively, the processing may proceed to step S310 to form an image every time a sheet's worth (a medium's worth) of image data are received in step S309.

Next, in step S312, the image forming part 51 notifies the image forming filter 321 of the progress of the print job. Next, in step S313, a print job progress report is output from the image forming filter 321 to the slave unit printing part 222. Next, in step S314, a print job progress report is output from the slave unit printing part 222 to the communications server 12.

Next, in step S315, a request to notify the master unit of the progress of the print job is output from the communications server 12b to the communications part 52. A print job progress report is output from the communications part 52 to the communications part 52 of the master unit based on step S315. Based on this, the master unit executes, for example, processing such as step S228 of FIG. 7.

The above-described processing of steps S312 through S315 is repeated, for example, every time an image is formed on a medium, thereby notifying the master unit of the progress of the print job. Regarding the frequency of notification, a notification (report) may be made every time an image is formed on a medium, every time one copy is finished, or at predetermined time intervals. Further, the master unit can be informed of completion of the print job by reporting completion of the print job to the master unit as the progress of the print job.

Next, in step S316, a printing completion notification received from the master unit by the communications part 52 is output from the communications part 52 to the communications server 12. The printing completion notification received from the master unit may be, for example, a notification transmitted from the communications part 52 of the master unit based on step S234 of FIG. 7.

Next, in step S317, a printing completion notification is output from the communications server 12 to the slave unit printing part 222. Then, after step S317, the processing proceeds to steps S318 and S319.

In step S319, a reception completion notification to report completion of the print job and completion of reception of image data is output from the slave unit printing part 222 to the reception filter 305. Simultaneously with or before or after (that is, asynchronously with) step S318, in step S319, a printing completion notification to report completion of the print job is output from the slave unit printing part 222 to the image forming filter 321.

The job of linked printing is completed and the job in the slave unit is completed by the above-described processing of steps S316 through S319. It is possible to respond to redistribution of a job due to trouble in the master unit or another slave unit because completion of the job is based on the notification from the master unit in step S316.

(Sequence Diagram of Processing in Case of Stack Printing [Master Unit])

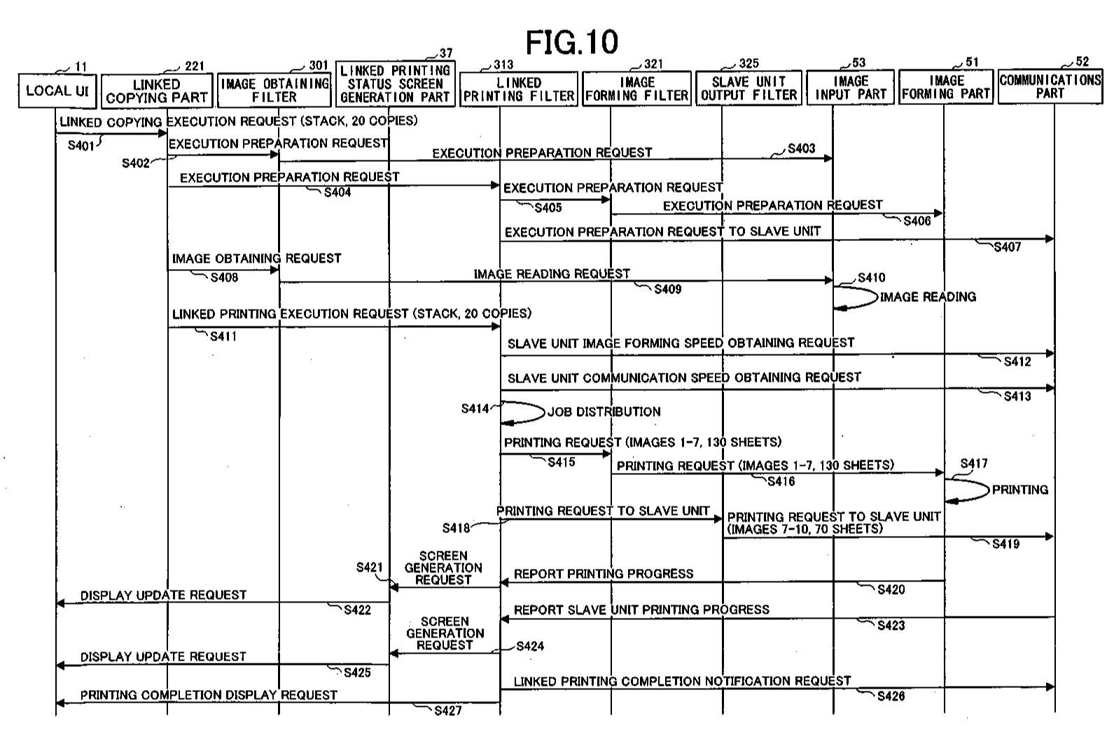

FIG. 10 is a sequence diagram illustrating processing in a master unit in the case of performing stack printing according to one embodiment of the present invention.

Stack printing is a printing method that successively outputs media image by image from an image processor in the case of forming multiple images on media different from each other. In the case of performing stack printing as a linked printing job, stack printing is performed using a combination of one master unit and one slave unit. Further, for example, if there are ten images, the master unit outputs media in order from those of the first image while the slave unit outputs media in (backward) order from those of the tenth image. By stacking the output media, it is possible to obtain the same output results as in the case of having media output from a single image processor.

The processing of steps S401 through S413 of FIG. 10 is substantially the same as the processing of steps S201 through S216 of FIG. 7. A first difference lies in that “sort” is replaced with “stack” in the information output at the time of making the linked copying execution request (step S401) and the linked printing execution request (step S411). A second difference lies in that the number of execution preparation requests to slave units is different because there are two slave units in the case of FIG. 7 while there is one slave unit in the case of FIG. 10. The processing is the same in the other respects than the above-described differences, and accordingly, a description thereof is omitted.

In step S414 of FIG. 10, the job of linked printing is distributed (divided) between the master unit and the slave unit based on the image forming speed of the slave unit obtained based on step S412 and/or the speed of communications with the slave unit obtained based on step S413. The linked copying execution request output in step S401 is a request for stack printing that outputs 20 copies (media) with respect to each of ten images, and the number of media (or sheets) to be output is 200 in total. Therefore, 200 sheets are divided (distributed) between the master unit and the slave unit. Here, the master unit is assigned 130 sheets while the slave unit is assigned 70 sheets. The master unit needs the first through seventh images (images 1 through 7) in order to output the 130 sheets of images. On the other hand, the slave unit needs the seventh through tenth images (images 7 through 10) in order to output the 70 sheets of images.

The processing proceeds to steps S415 and S418 after step S414. In step S415, a printing request is output from the linked printing filter 313 to the image forming filter 321. The printing request may contain, for example, the image data 1 through 7 of images to be formed by the master unit and information such as “130,” which shows the number of sheets. Next, in step S416, a printing request is output from the image forming filter 321 to the image forming part 51. Next, in step S417, the image forming part 51 forms and outputs images on media.

On the other hand, simultaneously with or before or after (that is, asynchronously with) step S415, in step S418 subsequent to step S414, a printing request to the slave unit is output from the linked printing filter 313 to the slave unit output filter 325. The printing request to the slave unit may contain, for example, the image data 7 through 10 of images to be output by the slave unit and information such as “70,” which shows the number of sheets to be output by the slave unit. Next, in step S419, a printing request to the slave unit is output from the slave unit output filter 325 to the communications part 52. The communications part 52 outputs a printing request to the slave unit based on step S419.

The subsequent processing of steps S420 through S427 is substantially the same as the processing of steps S225 through S235 of FIG. 7. In more detail, the processing of steps S420 through S427 is the same as the processing of steps S225 through S235 of FIG. 7 except that there is one slave unit in the case of FIG. 10 while there are two slave units in the case of FIG. 7 so that the processing with respect to the second slave unit 2 of FIG. 7 is not included in FIG. 10, and accordingly, a description thereof is omitted.

(Sequence Diagram Illustrating Processing in Case of Occurrence of Jam in Master Unit)

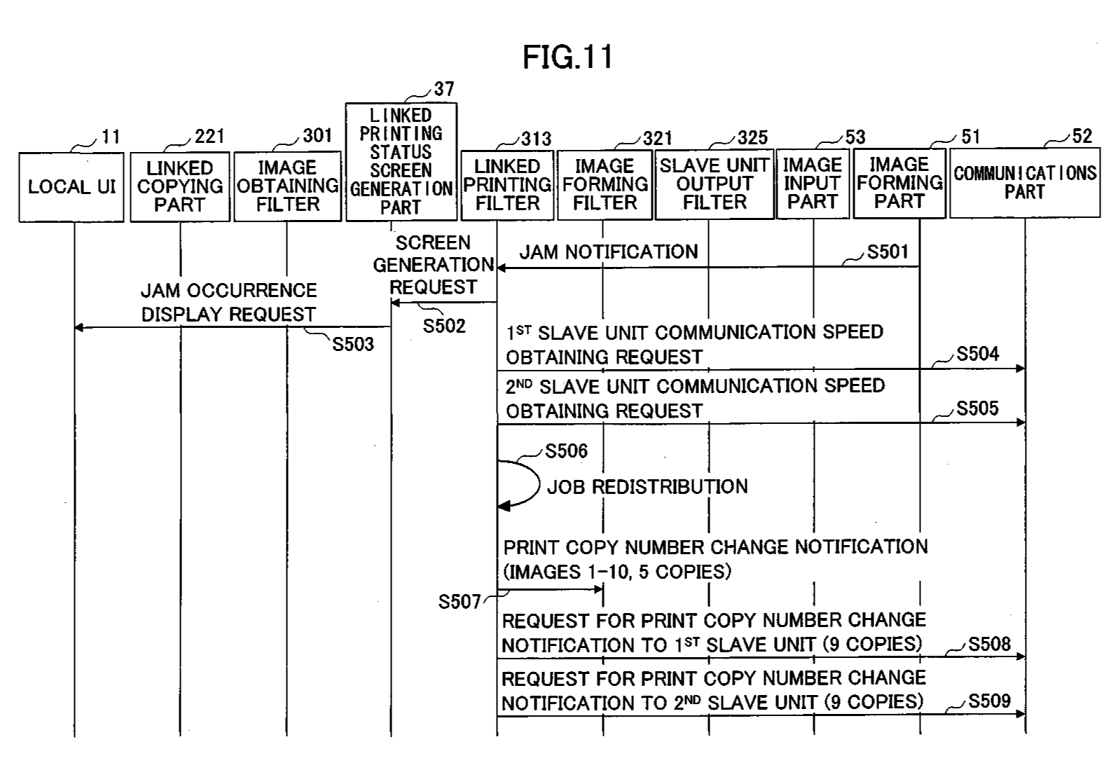

FIG. 11 is a sequence diagram illustrating processing in the case of occurrence of a jam in a master unit during execution of a job of linked printing according to one embodiment of the present invention.

In the case of FIG. 11, the job is redistributed based on a jam notification that reports occurrence of a jam. FIG. 11 shows the case where a jam occurs in a job of linked printing that executes sort printing.

Referring to FIG. 11, in step S501, a jam notification is output from the image forming part 51 to the linked printing filter 313. The jam notification may be output from the image forming filter 321 to the linked printing filter 313 after being output from the image forming part 51 to the image forming filter 321. Further, the jam notification may be obtained by the progress obtaining part 35 of the linked printing filter 313, which obtains normal current progress, or by a part not graphically illustrated that obtains other abnormal notifications.

Next, in step S502, a screen generation request is output from the linked printing filter 313 to the linked printing status screen generation part 37 of the linked printing filter 313. The linked printing status screen generation part 37 generates a jam notification screen for reporting occurrence of a jam based on step S502. Next, in step S503, a jam occurrence display request requesting display of the jam notification screen is output from the linked printing status screen generation part 37 to the local UI part 11.

On the other hand, the processing of steps S504 through S509 is performed asynchronously with step S503 after step S502. In step S504, a communication speed obtaining request requesting information on the speed of communications with a first slave unit is output from the communication speed obtaining part 33 of the linked printing filter 313 to the communications part 52. Next, in step S505, a communication speed obtaining request requesting information on the speed of communications with a second slave unit is output from the communication speed obtaining part 33 of the linked printing filter 313 to the communications part 52. Based on steps S504 and S505, the communications part 52 obtains the speed of communications with the first slave unit and the speed of communications with the second slave unit, and outputs the information on the speeds of communications to the linked printing filter 313.

Next, in step S506, the image number ratio determination part 31 and the image number determination part 39 redetermines how to divide or share the job between the first slave unit and the second slave unit. In more detail, the image number ratio determination part 31 and the image number determination part 39 newly determine the number of image copies to be output with respect to each of the first and second slave units. Here, the image forming part 51 of the master unit, the first slave unit, and the second slave unit are newly assigned five copies (sets), nine copies (sets), and nine copies (sets), respectively. The number “five” newly assigned to the image forming part 51 of the master unit is the number of copies (sets) that have already been output.

Next, in step S507, the linked printing filter 313 notifies the image forming filter 321 of information showing “five,” which is the number of copies newly assigned in step S506. Next, in step S508, a request to transmit a print copy (set) number change notification notifying the first slave unit of the number of copies newly assigned thereto is output from the linked printing filter 313 to the communications part 52. Next, in step S509, a request to transmit a print copy (set) number change notification notifying the second slave unit of the number of copies newly assigned thereto is output from the linked printing filter 313 to the communications part 52.

In each of steps S508 and S509, the request to notify the slave unit of the number of copies newly assigned thereto may be output from the linked printing filter 313 to the communications part 52 via the slave unit output filter 325 instead of being output from the linked printing filter 313 directly to the communications part 52.

Further, steps S507 through S509 may be performed either synchronously or asynchronously.

(Sequence Diagram Illustrating Processing in Case of Occurrence of Jam in Slave Unit)

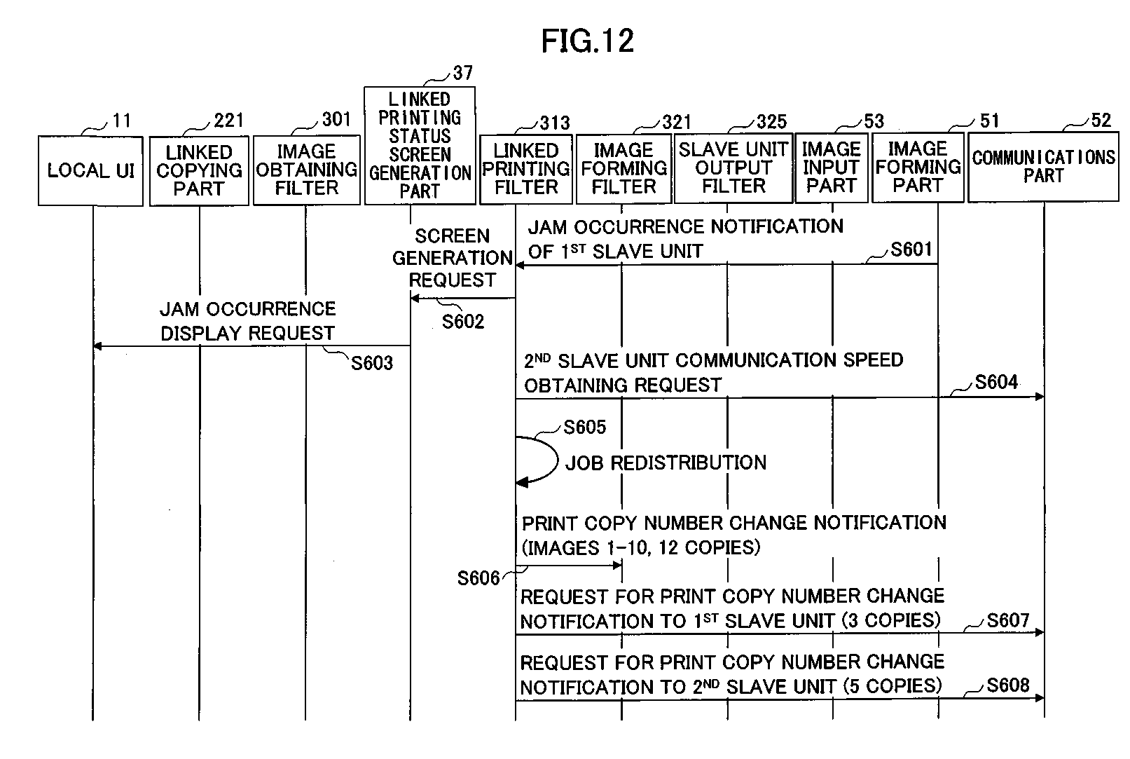

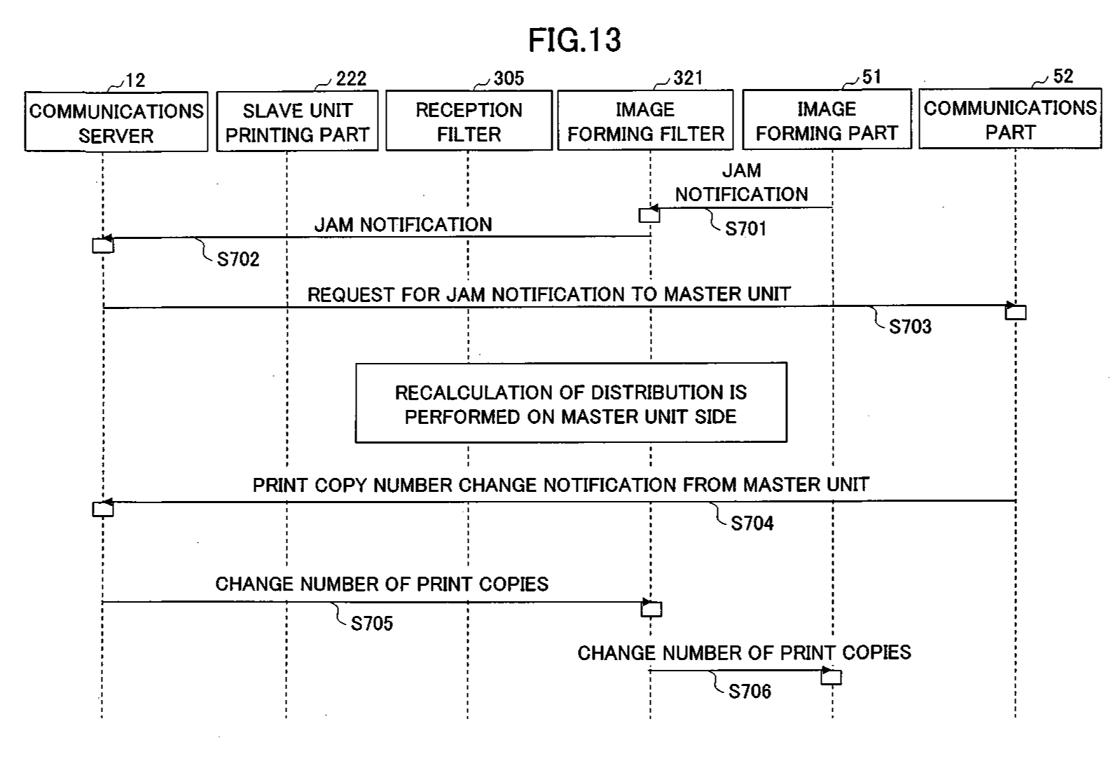

FIGS. 12 and 13 are sequence diagrams illustrating processing in the case of occurrence of a jam in a slave unit during execution of a job of linked printing according to one embodiment of the present invention.

FIG. 12 shows processing in a master unit, and FIG. 13 shows processing in the slave unit. FIGS. 12 and 13 show the case where a jam occurs in a job of linked printing that executes sort printing.

(Sequence Diagram Illustrating Processing in Case of Occurrence of Jam in Slave Unit [Master Unit])

In the processing of FIG. 12, a job is redistributed based on a jam notification reporting occurrence of a jam.

In step S601 of FIG. 12, a jam occurrence notification transmitted from a first slave unit is output from the communications part 52 to the linked printing filter 313. The jam occurrence notification may also be output from the communications part 52 to the linked printing filter 313 via the slave unit output filter 325 instead of being output from the communications part 52 directly to the linked printing filter 313. The jam occurrence notification may be obtained by the progress obtaining part 35 of the linked printing filter 313 or by other parts.

In step S602, a jam occurrence notification (a screen generation request) is output from the linked printing filter 313 to the linked printing status screen generation part 37 of the linked printing filter 313. Based on step S602, the linked printing status screen generation part 37 generates a display screen showing occurrence of a jam in the first slave unit.

Next, in step S603, a jam occurrence display request is output from the linked printing status screen generation part 37 to the local UI part 11. The jam occurrence display request may contain, for example, the display screen generated by the linked printing status screen generation part 37 for notifying an operator of occurrence of a jam in the first slave unit.

Subsequently to step S603 or asynchronously with step S602, in step S604, the communication speed obtaining part 33 of the linked printing filter 313 outputs a request to obtain the speed of communications with a second slave unit to the communications part 52. Based on step S604, the communications part 52 outputs information on the speed of communications with the second slave unit to the communication speed obtaining part 33.

Next, in step S605, the image number ratio determination part 31 and the image number determination part 39 of the linked printing filter 313 redistribute the job of linked printing. In the case of FIG. 12, the job of linked printing is redistributed so that the master unit, the first slave unit, and the second slave unit output 12 copies, three copies, and five copies, respectively.

Next, in step S606, a print copy (set) number change notification containing information such as “12,” which is the number of copies (sets) newly assigned, is output from the linked printing filter 313 to the image forming filter 321.

Next, in step S607, a request to transmit a print copy (set) number change notification notifying the first slave unit of the number of copies newly assigned thereto is output from the linked printing filter 313 to the communications part 52. Next, in step S608, a request to transmit a print copy (set) number change notification notifying the second slave unit of the number of copies newly assigned thereto is output from the linked printing filter 313 to the communications part 52. In each of steps S607 and S608, the request to notify the slave unit of the number of copies newly assigned thereto may be output from the linked printing filter 313 to the communications part 52 via the slave unit output filter 325 instead of being output from the linked printing filter 313 directly to the communications part 52.

Further, steps S606 through S608 may be performed either synchronously or asynchronously.

(Sequence Diagram Illustrating Processing in Case of Occurrence of Jam in Slave Unit [Slave Unit])

In the processing of FIG. 13, a jam notification reporting a jam is output based on its occurrence and a job is performed based on its redistribution (new distribution) from a master unit.

In step S701 of FIG. 13, a jam notification is output from the image forming part 51 to the image forming filter 321. Next, in step S702, a jam occurrence notification reporting occurrence of a jam in the image forming part 51 is output from the image forming filter 321 to the communications server 12.

Next, in step S703, a jam notification request or a request to notify a master unit of occurrence of a jam is output from the communications server 12 to the communications part 52.

Based on step S703, the master unit redistributes the job and notifies the slave unit of the redistribution. In step S704, a print copy (set) number change notification from the master unit is output from the communications part 52 to the communications server 12. The print copy number change notification contains, for example, information on the number of copies newly assigned. Step S704 may be based on, for example, processing such as step S607 of FIG. 12.

Next, in step S705, a notification to change the number of print copies (copies to be printed) is output from the communications server 12 to the image forming filter 321. Next, in step S706, a notification to change the number of print copies is output from the image forming filter 321 to the image forming part 51.

The processing of setting (determining) a new number of print copies is completed by the above-described processing of steps S704 through S706.

(Table Illustrating Job Distribution in Case of Implementing Sort Printing by Linked Printing)

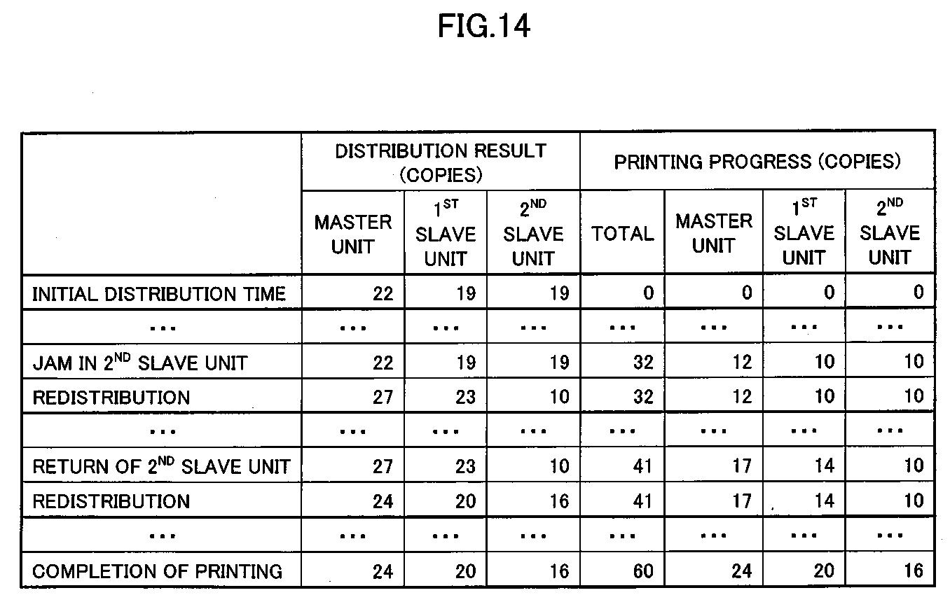

FIG. 14 is a table illustrating job distribution in the case of implementing sort printing by linked printing according to one embodiment of the present invention.

In the case of FIG. 14, linked printing is executed by three image processors: a master unit, a first slave unit, and a second slave unit. The master unit has an image forming speed of 44 ppm (pages per minute) and each of the first slave unit and the second slave unit has an image forming speed of 38 ppm. Further, in FIG. 14, 60 copies of a document of 10 sheets of images are output, and the output mode is sort printing.

Referring to FIG. 14, the master unit, the first slave unit, and the second slave unit are assigned 22 copies, 19 copies, and 19 copies, respectively, at INITIAL DISTRIBUTION TIME when a job of linked printing is started. This assignment is obtained by Eq. (2), which is based on Eq. (1), and Eq. (3) by which the number of copies to be made by each of the first slave unit and the second slave unit NCs is given as follows:

NCm=(44/(44+38+38))*60≈22(copies), (2)

NCs=(38/(44+38+38))*60≈19(copies). (3)

Equations (2) and (3) determine the number of copies to be made by the master unit and each of the first and second slave units, respectively, so that the master unit and the first and second slave units finish their respective print jobs simultaneously or as near to simultaneously as possible. Equations (2) and (3) do not perform adjustment in terms of communications speed. However, for example, if the speed of communications with the first or second slave unit is lower than a predetermined value, the number of copies to be assigned to the image processor (slave unit) may be reduced and the reduction may be assigned to another image processor. This makes it possible to execute a job of linked printing with efficiency.

Next, the print job makes progress, and when the master unit has output 12 copies and each of the first and second slave units has output ten copies, a jam occurs in the second slave unit and redistribution of the job is performed. The redistribution is determined based on Eq. (4) as follows:

(Number of copies to be made by an image processor)=((Image forming speed of the image processor)/(Total image forming speed))*(Total number of copies to be output−Total number of copies that have already been output)+Number of copies that have already been output by the image processor+Adjustment by communication speed. (4)

Based on Eq. (4), the master unit, the first slave unit, and the second slave unit are newly assigned a job of 27 copies, a job of 23 copies, and a job of 10 copies, respectively. In Eq. (4), “Number of copies that have already been output by the image processor” may not be used for the number to be newly assigned. However, addition of “Number of copies that have already been output by the image processor” makes it possible to notify an operator of the progress of the entire linked printing job more suitably at the time of displaying the progress of the job.

Next, the print job makes progress based on the newly assigned numbers, and when the master unit has output 17 copies and the first slave unit has output 14 copies while the output of the second slave unit remains ten copies so that 41 copies have been output in total, the second slave unit recovers and returns so that redistribution of the job is again performed. The redistribution in this case is determined based on Eq. (4), so that the master unit, the first slave unit, and the second slave unit are assigned 24 copies, 20 copies, and 16 copies, respectively. The linked printing job is finally completed based on this assignment.

(Table Illustrating Job Distribution in Case of Implementing Stack Printing by Linked Printing)

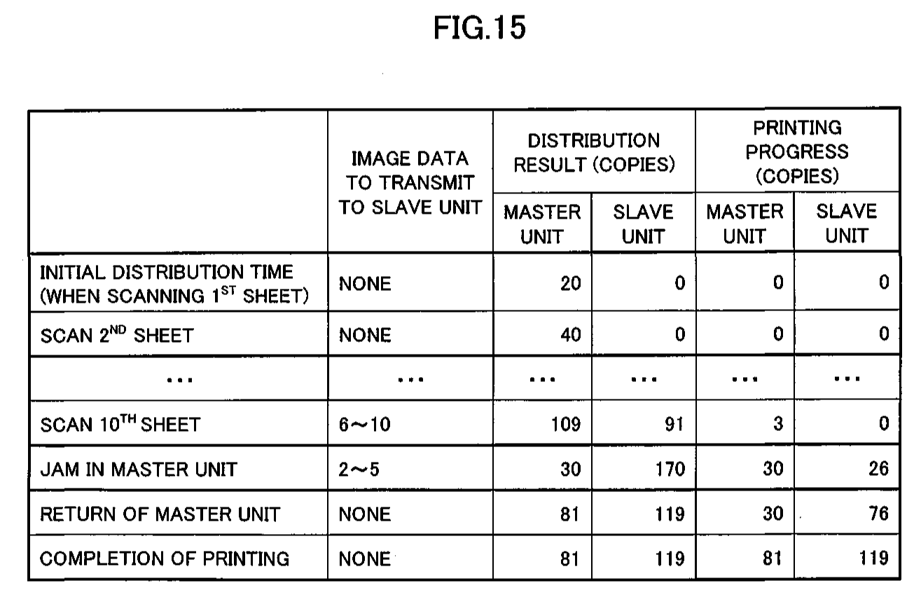

FIG. 15 is a table illustrating job distribution in the case of implementing a copying job by stack printing by linked printing according to one embodiment of the present invention.

In the stack printing of FIG. 15, linked printing is performed by two image processors: a master unit and a slave unit. It is assumed that the master unit and the slave unit have the same image forming speed. Further, it is assumed that 20 copies of a document of 10 sheets of images are to be output.

Referring to FIG. 15, a job is started based on, for example, the input of a linked copying job instruction and the numbers of copies and sheets of images from the local UI part 11. Therefore, at INITIAL DISTRIBUTION TIME of FIG. 15, which is a time when the first image (the first sheet of images) is scanned, the master unit is assigned 20 sheets (copies) of the first image as an output assignment. Likewise, when the second image (the second sheet of images) is scanned, the master unit is assigned 20 sheets (copies) of the second image, that is, the total of 40 sheets with the 20 sheets of the first image combined, as an output assignment. When the tenth image (the tenth sheet of images) is scanned, the master unit has formed and output three sheets of images. At this point, the master unit is assigned 109 sheets and the slave unit is assigned 91 sheets as their respective output assignments. Therefore, image data 6 through 10, which are the image data of images to be output by the slave unit, are output from the communications part 52 to the slave unit.

The linked printing job makes progress, and when the master unit has output 30 sheets and the slave unit has output 26 sheets, a jam occurs in the master unit and redistribution of the job is performed. Here, of the 109 sheets initially assigned to the master unit, 79 sheets not yet output are newly assigned to the slave unit, so that the assignment is 30 sheets to the master unit and 170 sheets to the slave unit. Therefore, image data 2 through 5, which are the image data of images to be newly output by the slave unit, are transmitted from the communications part 52 of the master unit to the slave unit.

The linked printing job makes further progress, and when the slave unit has output 76 sheets, the master unit recovers and returns so that redistribution of the job is again performed. As a result of the new redistribution, the master unit is assigned 81 sheets and the slave unit is assigned 119 sheets. By the master unit and the slave unit executing their respective assigned print jobs, the linked printing job is completed.

(Diagram Illustrating Configuring Software Implementing Linked Copying as Plug-In)

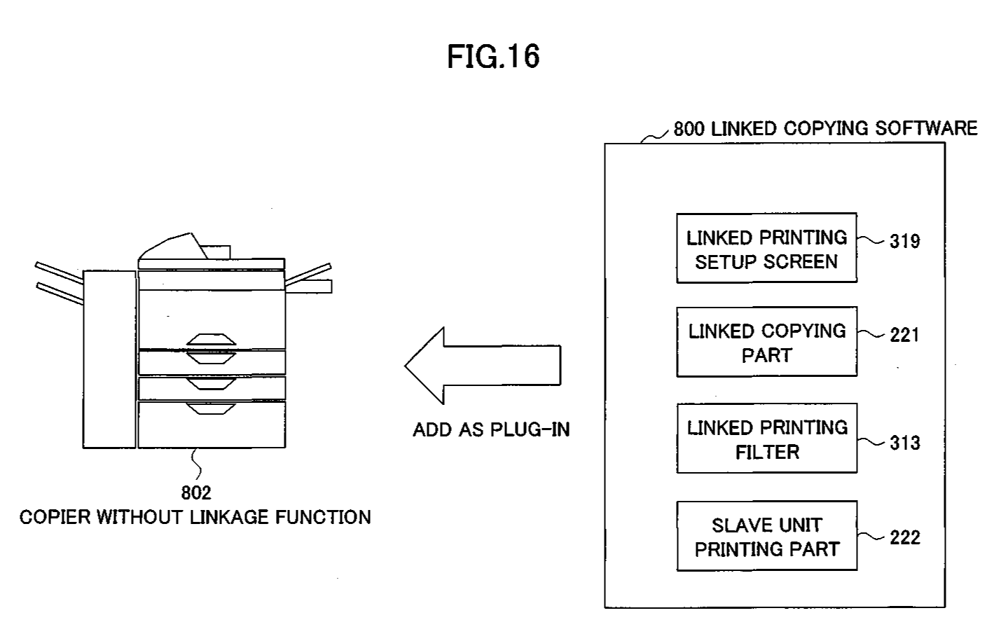

FIG. 16 is a diagram illustrating configuring software implementing linked copying as a plug-in according to one embodiment of the present invention.

Referring to FIG. 16, a screen for setting up linked printing (a linked printing setup screen) 319, the linked printing part 221, the linked printing filter 313, and the slave unit printing part 222 are contained in a plug-in as linked copying software 800. The configuration described with reference to FIG. 3 or FIG. 4 can be implemented by adding the linked copying software 800 as a plug-in to an image processor (such as a copier) without a linkage function 802.

The linked copying software 800 of FIG. 16 is one example, and the linked copying software 800 may be configured to contain, for example, at least one of the function implementation parts of the linked printing setup screen 319, the linked printing part 221, the linked printing filter 313, and the slave unit printing part 222.

(Example Connection of Image Processors Implementing Linked Facsimile Function)

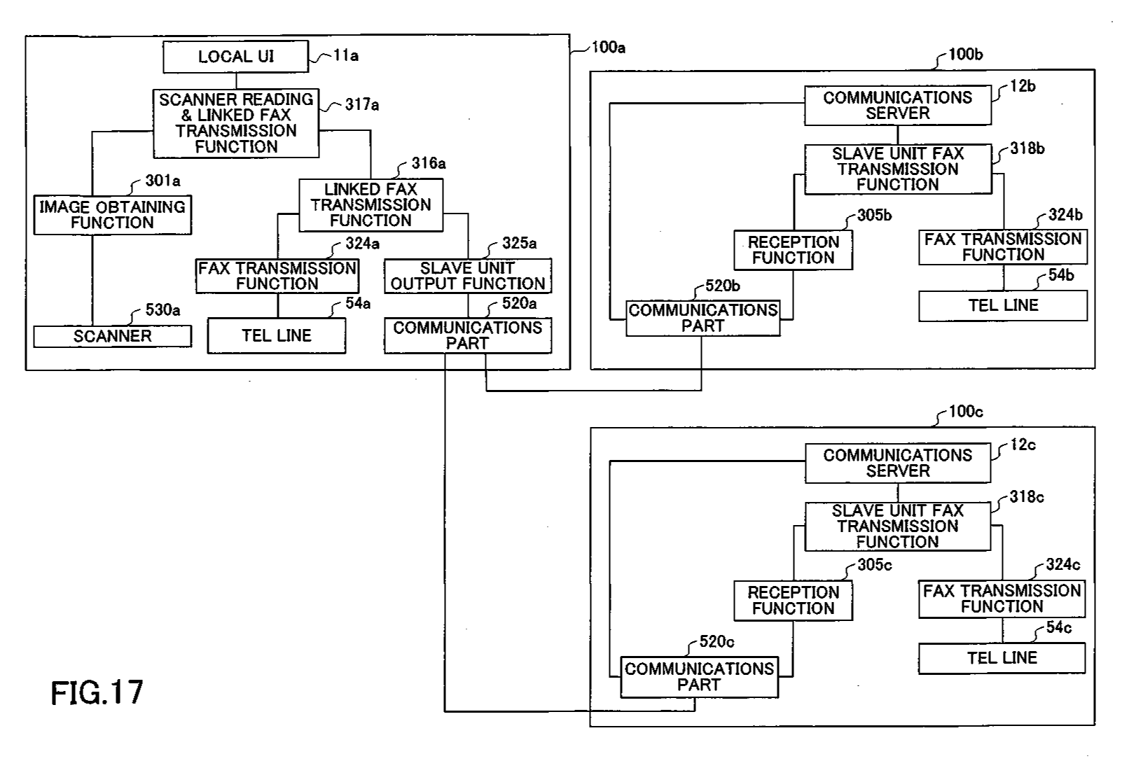

FIG. 17 is a diagram showing an example connection of image processors that implements a linked facsimile function according to one embodiment of the present invention.

Referring to FIG. 17, the MFP 100b and the MFP 100c to serve as slave units of linked facsimile are connected to the MFP 100a serving as a master unit of linked facsimile. In addition to a facsimile transmission function 324a, which is a function implementing facsimile transmission, a linked facsimile (FAX) transmission function 316a and a scanner reading and linked facsimile (FAX) function 317a are provided in the MFP 100a as functions that implement the linked facsimile function. The MFP 100a further includes a telephone (TEL) line 54a connected to the facsimile transmission function 324a.

Further, a slave unit facsimile (FAX) transmission function 318b and a facsimile (FAX) transmission function 324b are provided in the MFP 100b in order to implement a slave unit function of linked facsimile. The MFP 100b further includes a telephone (TEL) line 54b connected to the facsimile transmission function 324b.

As is clear from FIGS. 4 and 17, the linked facsimile function can be implemented by replacing filters related to the linked copying function with corresponding filters implementing the linked facsimile function.

FIGS. 4, 16, and 17 show that it is easy to add one or both of the linked copying function and the linked facsimile function to an image processor having neither the linked copying function nor the linked facsimile function.

The MFP 100c has the same configuration and functions as the MFP 100b, and a description thereof is therefore omitted.

(Computer Configuration)

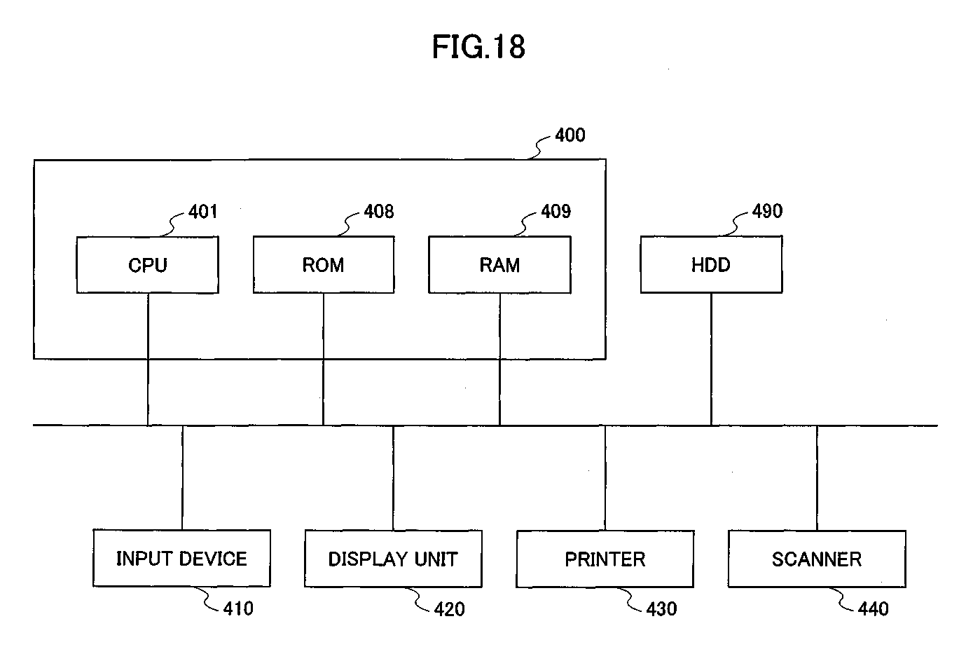

FIG. 18 is a block diagram showing a computer configuration implementing an image processor according to one embodiment of the present invention.

The computer of FIG. 18 includes a main processing part 400, an input device 410, a display unit 420, a printer 430, a scanner 440, and an HDD (hard disk drive) 490. The main processing part 400 includes a CPU 401, a ROM 408, and a RAM 409. The computer functions are mainly implemented by the main processing part 400.

The CPU 401 reads a computer program such as a linked printing program, a linked copying program, or a linked facsimile program from the ROM 408, and loads the computer program into the RAM 409, thereby executing a computer program that implements a linkage function according to one embodiment of the present invention. The ROM 408, which is a nonvolatile memory, retains programs implemented by the CPU 401, such as the linked printing program, and parameters necessary to control the image processor. The RAM 409 serves as working memory when the CPU 401 performs processing.

The input device 410 is, for example, a keyboard, and is used when an operator inputs instructions. The display unit 420 displays the status of the computer. The printer 430 is an apparatus that forms and outputs an image on a medium. The scanner 440 is an apparatus that optically reads an image formed on a medium. The HDD 490 stores large-capacity data such as image data.

The computer program that implements a linkage function according to one embodiment of the present invention may be contained in not only the HDD 490 or the ROM 408 but also a recording medium insertable into a drive unit (not graphically illustrated).

According to one aspect of the present invention, the linked copying function may correspond to a linked copying part, the linked printing function may correspond to a linked printing filter, the image obtaining function may correspond to an image obtaining filter, the image forming function may correspond to an image forming filter, the slave unit output function may correspond to the slave unit output filter, the reception function may correspond to a reception filter, the slave unit printing function may correspond to a slave unit printing part, the linked facsimile transmission function may correspond to a linked facsimile filter, and the facsimile transmission function may correspond to a facsimile transmission filter.

According to one embodiment of the present invention, there is provided an image processor implementing a linked printing function, including a communications part configured to perform communications with an external image processor having a slave unit function of linked printing; an image forming filter configured to execute a job of image forming with an image forming part; a slave unit output filter configured to instruct the external image processor to execute the job of the image forming through the communications part; and a linked printing filter configured to distribute the job of the image forming between the image forming filter and the slave unit output filter (Configuration 1).

As a result, it is possible to provide an image processor to which a linkage function can be added easily by combining the image forming function and the communications functions of the image processor with a function to be newly added.

Additionally, in the image processor as set forth in Configuration 1, the linked printing filter may include an image number ratio determination part configured to determine the ratio of the number of images to be formed by the image forming part to the number of images to be formed by the external image processor (Configuration 2).

As a result, it is possible to provide an image processor that determines the ratio of the numbers of images to be formed by the image forming part and another image processor.

Additionally, in the image processor as set forth in Configuration 2, the image number ratio determination part may be configured to determine the ratio based on at least one of the ratio of the speed of the image forming of the image forming part to the speed of the image forming of the external image processor, a speed of communications with the external image processor, and the ratio of the progress of the image forming in the image forming part to the progress of the image forming in the external image processor (Configuration 3).

As a result, the time required for image forming can be substantially the same for the image forming part and another image processor.

Additionally, in the image processor as set forth in Configuration 2, the linked printing filter may further include a slave unit specifications obtaining part configured to obtain the specifications of at least one of a slave unit and a candidate slave unit of the linked printing, the specifications including the speed of the image forming of the external image processor (Configuration 4).

As a result, it is possible to determine the image number ratio based on the specification of image forming speed.

Additionally, in the image processor as set forth in Configuration 2, the linked printing filter may further include a communication speed obtaining part configured to obtain the speed of the communications with the external image processor (Configuration 5).

As a result, it is possible to determine the image number ratio based on the speed of communications with another image processor.

Additionally, in the image processor as set forth in Configuration 2, the linked printing filter may further include a progress obtaining part configured to obtain the progress of the image forming in the image forming part (Configuration 6).

As a result, it is possible to determine the image number ratio based on the progress of image forming in the image forming part.

Additionally, in the image processor as set forth in Configuration 6, the progress obtaining part may further be configured to obtain the progress of the image forming in the external image processor through the communications part (Configuration 7).

As a result, it is possible to determine the image number ratio based on the progress of image forming in another image processor.

Additionally, in the image processor as set forth in Configuration 2, the image number ratio determination part may be configured to determine the ratio, when the external image processor is plural in number, based on at least one of the ratio of the speeds of the image forming of the image forming part and the external image processors, the speeds of the communications with the external image processors, and the ratio of the progress of the image forming in the image forming part and the external image processors (Configuration 8).

As a result, the time required for image forming can be substantially the same for a master unit and multiple slave units.

Additionally, the image processor as set forth in Configuration 2 may further include an input part configured to receive an input of the number of outputs of an image to be output, wherein the image number ratio determination part may be configured to determine the number of outputs of the image to be formed by the image forming part and the number of outputs of the image to be formed by the external image processor based on the number of outputs input from the input part and the ratio (Configuration 9).

As a result, it is possible to provide an image processor that suitably divides the number of outputs input by an operator between the image processor and another image processor.

Additionally, in the image processor as set forth in Configuration 1, the linked printing filter may be configured to output, when the image forming part and the external image processor are to form first and second different images, respectively, in the case of forming multiple images by the linked printing, the image data of the first image to the image forming filter and the image data of the second image to the slave unit output filter (Configuration 10).

As a result, the image data of an image to be output by another image processor performing linked printing can be transmitted to the other image processor.

Additionally, the image processor as set forth in Configuration 1 may further include an image obtaining filter configured to obtain the image data of an input image; and a linked copying part configured to implement linked copying by instructing the linked printing filter to execute a job of forming the image based on the image data obtained from the image obtaining filter (Configuration 11).

As a result, it is possible to output an image by linked copying with a filter that implements copying an input image.

According to one embodiment of the present invention, there is provided an image processor implementing a linked printing function, including a reception filter configured to receive a job instruction transmitted from an external image processor having a master unit function of linked printing, the job instruction containing image data and the number of outputs of an image to be formed based on the image data; an image forming filter configured to output an instruction to form the image to an image forming part; and a slave unit printing part configured to output the image data and the number of outputs to the image forming filter based on the job instruction from the external image processor (Configuration 12).

As a result, it is possible to provide an image processor that implements a slave unit function of linked printing by a combination of filters.

Additionally, in the image processor as set forth in Configuration 12, the slave unit printing part may be configured to transmit the progress of the forming of the image by the image forming part to the external image processor (Configuration 13).

As a result, transmission of the progress of formation of an image of linked printing to a master unit can be implemented with filters.

According to one embodiment of the present invention, there is provided an image processor implementing a linked facsimile function, including a communications part configured to perform communications with an external image processor having a slave unit function of linked facsimile; a facsimile transmission filter configured to execute a job of facsimile transmission with a facsimile part; a slave unit output filter configured to instruct the external image processor to execute the job of the facsimile transmission through the communications part; and a linked facsimile filter configured to implement a master unit function of the linked facsimile by distributing the job of the facsimile transmission between the facsimile transmission filter and the slave unit output filter (Configuration 14).

As a result, it is possible to provide an image processor that implements a master unit function of linked facsimile with filters.

According to one embodiment of the present invention, there is provided an image processing method of an image processor implementing a linked printing function, the image processing method including the image forming step of an image forming filter executing a job of image forming with an image forming part; the slave unit output step of a slave unit output filter instructing an external image processor to execute the job of the image forming through a communications part, the external image processor having a slave unit function of linked copying; and the linked printing step of a filter implementing a master unit function of the linked printing by distributing the job of the image forming between the image forming filter and the slave unit output filter (Configuration 15).

According to one embodiment of the present invention, there is provided an image processing method of an image processor implementing a linked printing function, the image processing method including the reception step of a first filter receiving a job instruction transmitted from an external image processor having a master unit function of linked printing, the job instruction containing image data and the number of outputs of an image to be formed based on the image data; the image forming step of a second filter outputting an instruction to form the image to an image forming part; and the slave unit printing step of a third filter outputting the image data and the number of outputs to the second filter based on the job instruction from the external image processor (Configuration 16).

According to one embodiment of the present invention, there is provided a computer program implementing a linked printing function by causing a computer to execute the image forming step of an image forming filter executing a job of image forming with an image forming part; the slave unit output step of a slave unit output filter instructing an external image processor to execute the job of the image forming through a communications part, the external image processor having a slave unit function of linked copying; and the linked printing step of implementing a master unit function of the linked printing by distributing the job of the image forming between the image forming filter and the slave unit output filter (Configuration 17).

According to one embodiment of the present invention, there is provided a computer program implementing a linked printing function by causing a computer to execute the reception step of a first filter receiving a job instruction transmitted from an external image processor having a master unit function of linked printing, the job instruction containing image data and the number of outputs of an image to be formed based on the image data; the image forming step of a second filter outputting an instruction to form the image to an image forming part; and the slave unit printing step of a third filter outputting the image data and the number of outputs to the second filter based on the job instruction from the external image processor (Configuration 18).

According to one embodiment of the present invention, there is provided a computer program to be added to an image processor as a plug-in, the image processor including a communications part configured to perform communications with an external image processor having a slave unit function of linked printing; an image forming filter configured to execute a job of image forming with an image forming part; and a slave unit output filter configured to instruct the external image processor to execute the job of the image forming through the communications part, wherein the computer program causes the image processor to execute the step of distributing the job of the image forming between the image forming filter and the slave unit output filter (Configuration 19).

According to one embodiment of the present invention, there is provided a computer program to be added to an image processor as a plug-in, the image processor including a reception filter configured to receive a job instruction transmitted from an external image processor having a master unit function of linked printing, the job instruction containing image data and the number of outputs of an image to be formed based on the image data; and an image forming filter configured to output an instruction to form the image to an image forming part, wherein the computer program causes the image processor to execute the step of outputting the image data and the number of outputs to the image forming filter based on the job instruction from the external image processor (Configuration 20).

According to one embodiment of the present invention, there is provided an image processor having a master unit function of linked printing, the image processor including a slave unit list retention part configured to retain identification information of one or more external image processors each having a slave unit function of the linked printing and performing communications with the image processor; and a slave unit selection screen generation part configured to generate a slave unit selection screen for selecting one or more of the external image processors as slave units to which a job of the linked printing is to be assigned (Configuration 21).

As a result, it is possible to provide an image processor that generates a screen suitably displaying a list of image processors that are candidate slave units in the case of implementing a linkage function, thereby facilitating selection of a slave unit.

Additionally, the image processor as set forth in Configuration 21 may further include a slave unit specifications obtaining part configured to obtain specifications of the other external image processors, wherein the slave unit selection screen generation part may be configured to generate the slave unit selection screen based on the specifications of the other image processors obtained by the slave unit specifications obtaining part (Configuration 22).

As a result, it is possible to provide an image processor that generates a slave unit selection screen based on the specifications of other image processors.

Additionally, the image processor as set forth in Configuration 21 may further include a slave unit job status obtaining part configured to obtain the status of the job in the external image processors, wherein the slave unit selection screen generation part may be configured to generates the slave unit selection screen based on the status of the job in the other external image processors obtained by the slave unit job status obtaining part (Configuration 23).

As a result, it is possible to provide an image processor that generates a slave unit selection screen based on the status of a job in other image processors.

Additionally, in the image processor as set forth in Configuration 23, the slave unit selection screen may display the identification information of the external image processors in increasing order of waiting periods thereof based on the status of the job in the external image processors (Configuration 24).

As a result, it is possible to provide an image processor that displays the identification information of other image processors that are candidate slave units in increasing order of their waiting periods.

Additionally, in the image processor as set forth in Configuration 23, the slave unit selection screen generation part may be further configured to update the slave unit selection screen every time the slave unit job obtaining part obtains the status of the job from one of the external image processors (Configuration 25).

As a result, it is possible to provide an image processor that updates a slave unit selection screen every time the status of a job of another image processor is obtained.

Additionally, in the image processor as set forth in Configuration 21, the slave unit selection screen may include an identification information input field for inputting the identification information of the one or more external image processors so that the one or more external image processors are selected as the slave units of the linked printing (Configuration 26).

As a result, it is possible to provide an image processor that generates a slave unit selection screen for selecting another image processor to serve as a slave unit by inputting identification information.

Additionally, the image processor as set forth in Configuration 21 may further include a progress obtaining part configured to obtain progress of the job of the linked printing when the image processor and the external image processors are executing the job of the linked printing and forming an image; and a linked printing status screen generation part configured to generate a linked printing status screen displaying the progress of the job of the linked printing (Configuration 27).

As a result, it is possible to provide an image processor that obtains and displays the progress of a job of linked printing.

Additionally, in the image processor as set forth in Configuration 27, the linked printing status screen generation part may be further configured to update the linked printing status screen every time the progress obtaining part obtains the progress of the job of the linked printing (Configuration 28).

As a result, it is possible to provide an image processor that updates a linked printing status screen every time the progress of a job of linked printing is obtained.

Additionally, in the image processor as set forth in Configuration 27, the linked printing status screen may be further configured to include a linked printing change input field for inputting a change in the assignment of the job of the linked printing (Configuration 29).

As a result, it is possible to provide an image processor that generates a linked printing status screen having a linked printing change input field for inputting a change in the assignment of a job of linked printing.

According to one embodiment of the present invention, there is provided a linked printing control screen generation method in an image processor having a master unit function of linked printing, the linked printing control screen generation method including the identification information obtaining step of obtaining a list of identification information of one or more external image processors from a slave unit list retention part retaining the list, the one or more external image processors each having a slave unit function of the linked printing and performing communications with the image processor; and the slave unit selection screen generation step of generating, based on the identification information of the external image processors, a slave unit selection screen for selecting slave units to which a job of the linked printing is to be assigned (Configuration 30).

According to one embodiment of the present invention, there is provided a linked printing control screen generation program in an image processor having a master unit function of linked printing, the linked printing control screen generation program causing a computer to execute the identification information obtaining step of obtaining a list of identification information of one or more external image processors from a slave unit list retention part retaining the list, the one or more external image processors each having a slave unit function of the linked printing and performing communications with the image processor; and the slave unit selection screen generation step of generating, based on the identification information of the external image processors, a slave unit selection screen for selecting slave units to which a job of the linked printing is to be assigned (Configuration 31).

The present invention is not limited to the specifically disclosed embodiments, and variations and modifications may be made without departing from the scope of the present invention.

The present application is based on Japanese Priority Patent Applications No. 2006-314666 and No. 2006-314667, both filed on Nov. 21, 2006, the entire contents of which are hereby incorporated by reference.

What is claimed is:

1. An image processor implementing a linked printing function, comprising:
a communications part configured to perform communications with an external image processor having a slave unit function of linked printing;
an image forming filter configured to execute a job of image forming with an image forming part;
a slave unit output filter configured to instruct the external image processor to execute the job of the image forming through the communications part; and
a linked printing filter configured to distribute the job of the image forming between the image forming filter and the slave unit output filter.

2. The image processor as claimed in claim 1, wherein the linked printing filter comprises:
an image number ratio determination part configured to determine a ratio of a number of images to be formed by the image forming part to a number of images to be formed by the external image processor.

3. The image processor as claimed in claim 2, wherein the image number ratio determination part is configured to determine said ratio based on at least one of a ratio of a speed of the image forming of the image forming part to a speed of the image forming of the external image processor, a speed of the communications with the external image processor, and a ratio of progress of the image forming in the image forming part to progress of the image forming in the external image processor.

4. The image processor as claimed in claim 2, wherein the linked printing filter further comprises:
a slave unit specifications obtaining part configured to obtain specifications of at least one of a slave unit and a candidate slave unit of the linked printing, the specifications including a speed of the image forming of the external image processor.

5. The image processor as claimed in claim 2, wherein the linked printing filter further comprises:
a communication speed obtaining part configured to obtain a speed of the communications with the external image processor.

6. The image processor as claimed in claim 2, wherein the linked printing filter further comprises:
a progress obtaining part configured to obtain progress of the image forming in the image forming part.

7. The image processor as claimed in claim 6, wherein the progress obtaining part is further configured to obtain progress of the image forming in the external image processor through the communications part.

8. The image processor as claimed in claim 2, wherein the image number ratio determination part is configured to determine said ratio, when the external image processor is plural in number, based on at least one of a ratio of speeds of the image forming of the image forming part and the external image processors, speeds of the communications with the external image processors, and a ratio of progress of the image forming in the image forming part and the external image processors.

9. The image processor as claimed in claim 2, further comprising:
an input part configured to receive an input of a number of outputs of an image to be output,
wherein the image number ratio determination part is configured to determine a number of outputs of the image to be formed by the image forming part and a number of outputs of the image to be formed by the external image processor based on the number of outputs input from the input part and said ratio.

10. The image processor as claimed in claim 1, wherein the linked printing filter is configured to output, when the image forming part and the external image processor are to form first and second different images, respectively, in a case of forming a plurality of images by the linked printing, image data of the first image to the image forming filter and image data of the second image to the slave unit output filter.

11. The image processor as claimed in claim 1, further comprising:
an image obtaining filter configured to obtain image data of an input image; and
a linked copying part configured to implement linked copying by instructing the linked printing filter to execute a job of forming the image based on the image data obtained from the image obtaining filter.

12. An image processor implementing a linked printing function, comprising:
a reception filter configured to receive a job instruction transmitted from an external image processor having a master unit function of linked printing, the job instruction containing image data and a number of outputs of an image to be formed based on the image data;
an image forming filter configured to output an instruction to form the image to an image forming part; and
a slave unit printing part configured to output the image data and the number of outputs to the image forming filter based on the job instruction from the external image processor.

13. The image processor as claimed in claim 12, wherein the slave unit printing part is configured to transmit progress of the forming of the image by the image forming part to the external image processor.

14. A computer program to be added to an image processor as a plug-in, the image processor including a communications part configured to perform communications with an external image processor having a slave unit function of linked printing; an image forming filter configured to execute a job of image forming with an image forming part; and a slave unit output filter configured to instruct the external image processor to execute the job of the image forming through the communications part,
wherein the computer program causes the image processor to execute a step of distributing the job of the image forming between the image forming filter and the slave unit output filter.

15. A computer-readable recording medium on which is recorded the computer program as claimed in claim 14.
